(19) United States
(12) Patent Application Publication
(10) Pub. No.: US 2025/0083040 A1
(43) Pub. Date: Mar. 13, 2025

(54) MATCHMAKING ARCHITECTURE FOR ONLINE GAME PLATFORM

(71) Applicant: Roblox Corporation, San Mateo, CA (US)

(72) Inventors: Karun Channa, Redwood City, CA (US); Xiaoqiong Wu, Danville, CA (US); Colin Ramsay Dillard, Redwood City, CA (US); Yachao Lu, San Mateo, CA (US); Changran Liu, Mountain View, CA (US); Mathieu Francois Chauvin, San Carlos, CA (US); David Chun Hsiao Kao, Mountain View, CA (US)

(73) Assignee: Roblox Corporation, San Mateo, CA (US)

(21) Appl. No.: 18/827,599

(22) Filed: Sep. 6, 2024

Related U.S. Application Data
(60) Provisional application No. 63/537,166, filed on Sep. 7, 2023.

(51) Int. Cl. A63F 13/48; A63F 13/216

(52) U.S. Cl. CPC A63F 13/48; A63F 13/216

(57) ABSTRACT

Matchmaking architecture for online game platforms. In some implementations, a computer-implemented method includes receiving a request from a user device for one or more active game instances of a game platform that currently execute on the game platform and which the user device is able to join. The processor determines particular indexes in a data structure based on the request, which are a subset of a stored plurality of indexes that store identifications of a respective subset of active game instances on the platform. Identifications of a set of candidate game instances are obtained from the particular indexes, and a set of eligible game instances is determined based on the identifications and based on eligibility criteria, the set of eligible game instances being available to join. The user device is caused to connect to one of the eligible game instances.

### CROSS-REFERENCE TO RELATED APPLICATIONS

This application claims priority under 35 U.S.C. 119 (e) to U.S. Provisional Patent Application No. 63/537,166, filed Sep. 7, 2023 and entitled, “Matchmaking Architecture for Online Game Platform,” which is incorporated by reference herein in its entirety.

### TECHNICAL FIELD

This disclosure relates to the field of computerized networked service for games and other virtual experiences, in particular, to methods, systems, and computer readable media for connecting player devices to online computer game servers.

### BACKGROUND

Some online gaming platforms allow users to join online games with other players via the Internet and/or other computer networks. Users of online gaming platforms may participate in multiplayer gaming environments in which games or parts of games have been created by other users. Some online gaming platforms include a matchmaking service that receives a request from a player to join a game. The matchmaking service finds one or more currently-active games that are matched to the player's criteria or attributes, and connects the player to a matched game or presents the player with options to join any of the matched games.

When many games and players use the gaming platform, a matchmaking service can be taxed with requests from players and the actions of searching for matching games for players. For example, a matchmaking service may scan all active game instances to determine which games are eligible and relevant to the player. Such a process may take a significant amount of processing resources and time to complete, which creates delays for a player who is waiting to join a game as well as consuming significant system resources including processing capability, network bandwidth, etc.

Furthermore, in some cases, when an active game of an online gaming service is updated, the users connected to game instances of that game are typically disconnected temporarily from the game instances so that the update is performed. Many of the disconnected users, and other users, may attempt to rejoin the updated game close in time after the update is complete, causing a large load of join requests to the online gaming platform. System resource expenditure and processing time may increase dramatically as the game platform attempts to fulfill all of the join requests.

Accordingly, there may exist a need for improved and more efficient determination of eligible games provided by a matchmaking service of an online gaming or metaverse platform (or other system), as well as improved ability of a matchmaking service to reconnect players to game instances after an update of a game.

The background description provided herein is to present the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Implementations of this application relate to a matchmaking architecture for an online game platform. In some implementations, a computer-implemented method includes receiving, by at least one processor, a request from a user device of a requesting user for one or more active game instances of a game platform that the user device is able to join. The one or more active game instances are a subset of a plurality of active game instances currently executing on the game platform. The processor determines one or more particular indexes in a data structure based on the request, the particular indexes being a subset of a plurality of indexes stored in the data structure, and each of the plurality of indexes storing identifications of a respective subset of the plurality of active game instances. The processor obtains identifications of a set of candidate game instances from the one or more particular indexes of the data structure and determines a set of eligible game instances based on the identifications of the set of candidate game instances and based on eligibility criteria, where the set of eligible game instances are available for the user device to join. The user device is connected to one of the set of eligible game instances.

Various implementations and examples of the method are described. For example, in some implementations, obtaining the identifications of the set of candidate game instances includes initially searching only the one or more particular indexes of the data structure prior to searching other indexes of the plurality of indexes. In some implementations, determining the one or more particular indexes based on the request includes determining one or more user characteristics of the requesting user and matching the one or more user characteristics to one or more game instance characteristics associated with the one or more particular indexes. In some implementations, the one or more user characteristics include at least one of: a geographical region of the user device, a language used by the requesting user, an age of the requesting user, a social network of the requesting user, or game type preferences of the requesting user. In some implementations, the one or more game instance characteristics associated with a respective index of the plurality of indexes are characteristics of the respective subset of game instances identified by the respective index, wherein the one or more game instance characteristics include at least one of: a geographical region of one or more servers executing the respective subset of game instances, one or more languages used by at least one player connected to the respective subset of game instances, social networks of players connected to the respective subset of game instances, ages of the players connected to the respective subset of game instances, or game types of the respective subset of game instances. In some implementations, the plurality of indexes are arranged in groups, each group associated with a different game instance characteristic and each group assigned a different priority when being scanned based on a corresponding user characteristic of the requesting user. \

In some implementations, the eligibility criteria include criteria associated with the requesting user or the user device of the requesting user, e.g., based on user preferences or settings, age and/or language of players in instance, network performance between user device and device executing instance, etc.; and/or can include general criteria not specific to the requesting user, e.g., number of open player slots in the instance, the network- and/or processing-load on the server executing the instance, etc. In some implementations, determining the set of eligible game instances includes: determining that none of the set of candidate game instances meets the eligibility criteria; determining one or more additional particular indexes in the data structure based on the request, wherein the one or more additional particular indexes are a subset of the plurality of indexes stored in the data structure; obtaining identifications of a second set of candidate game instances from the one or more additional particular indexes of the data structure; and determining the set of eligible game instances based on the identifications of the second set of candidate game instances.

In some implementations, determining the set of eligible game instances includes: determining that none of the set of candidate game instances meets the one or more eligibility criteria; and causing creation of a new game instance and storing an identification of the new game instance in at least one of the one or more particular indexes, wherein the new game instance is included in the set of eligible game instances. In some implementations, determining the set of eligible game instances includes omitting, from the set of eligible game instances, duplicate game instances that are assigned to multiple indexes of the one or more particular indexes. In some implementations, fetching the set of candidate game instances includes: sending a request from a matchmaking module to a query handler of an indexing module, wherein the request indicates the particular indexes in the data structure; retrieving, by the query handler, the set of candidate game instances from the one or more particular indexes of the data structure; and sending the set of eligible game instances to the matchmaking module by the query handler to perform a matchmaking process to determine one or more game instances available for the user device to join based on matchmaking criteria. In some implementations, the method further includes determining, from the set of eligible game instances, one or more matched game instances available for the user device to join based on matchmaking criteria.

In some implementations, a system comprises at least one processor coupled to a nontransitory computer readable medium having stored thereon software instructions that, when executed by the one or more processors, cause the one or more processors to perform operations. The operations include receiving game data that includes game events that indicate game state changes in a plurality of active game instances (or other virtual experience instances) currently executing on a game platform. For each of the game events: the game event is obtained from the game data and it is determined whether the game event is an indexing event including creation of a new game instance, update of one of the plurality of active game instances, or closing of one of the plurality of active game instances. In response to determining that the game event is an indexing event, it is determined whether a particular game instance associated with the game event is eligible to be joined by one or more players. If so eligible, one or more index assignments are determined for the particular game instance that target one or more particular indexes associated with one or more game instance characteristics of the particular game instance. The particular indexes are a subset of a plurality of game instance indexes that store references to the active game instances. One or more game state updates are written to the particular indexes in a data structure based on the index assignments. The particular indexes are scanned to find eligible game instances based on the game instance characteristics associated with the particular indexes matching one or more user characteristics of a requesting user of the game platform requesting to join a game instance.

Various implementations and examples of the system are described. For example, in some implementations, the operation of determining whether the particular game instance associated with the game event is eligible to be joined by one or more players is based on whether the particular game instance is at least one of: private to particular players, closed or pending for closure, full of players, or prohibited from general users. In some implementations, the one or more game instance characteristics of the game event include at least one of: a geographical region of a server executing the particular game instance, a language used by at least one player connected to the particular game instance, a social network of the at least one player, age of the at least one player, or game type of the particular game instance; and the one or more user characteristics of the requesting user include at least one of: a geographical region of a user device of the requesting user, a language used by the requesting user, an age of the requesting user, a social network of the requesting user, or one or more game type preferences of the requesting user.

In some implementations, the operation of receiving the game data includes receiving a stream of serialized game data that includes the game events provided by all game instances running on the game platform, and deserializing the game event from the serialized game data, and wherein the operations further comprise: determining a respective set of index assignments associated with each of a plurality of game events received in the game data; and writing a plurality of game state updates to indexes in the data structure based on the game events and the associated sets of index assignments.

In some implementations, the operations further include, in response to receiving a request from a requesting user device of the requesting user: determining the one or more particular indexes that are associated with the one or more game instance characteristics that match one or more user characteristics of the requesting user; and scanning the one or more particular indexes to obtain the eligible game instances to which the requesting user is able to join; and in response to determining that the one or more particular indexes do not store references to active game instances to which the requesting user is able to join, scanning one or more other indexes of the plurality of indexes for the one or more active game instances to which the requesting user is able to join. In some implementations, the data structure is a lookup table in an indexing module that is in communication with a matchmaking module of the game platform, wherein the matchmaking module determines one or more game instances for the requesting user to join from the eligible game instances based on matchmaking criteria.

In some implementations, a computer-implemented method includes receiving, by at least one processor, an indication that original game instances of a game executing on a game platform are closing to enable an update of the game, where player devices of one or more players connected to the original game instances are to be disconnected from the original game instances for the update of the game. The processor stores one or more player reservations for the one or more players in a stored reservation map that maps the one or more player reservations to one or more player slots of the original game instances. The processor updates the game with one or more code changes to the game and executing one or more updated game instances for the game. After the update of the game and disconnection of the player devices from the original game instances, a request is received from a player device of a requesting player to connect to the game. In response to the request, the processor searches the reservation map for an associated player reservation corresponding to the requesting player for the game. In response to finding the associated player reservation in the reservation map, the processor connects a player device of the requesting player to one of the updated game instances that corresponds to the original game instance associated with the associated player reservation.

Various implementations and examples of the method are described. For example, in some implementations, in response to not finding the associated player reservation in the reservation map, performing, by the at least one processor, a matchmaking process to determine an active game instance or create a new game instance of the game to which the player device of the requesting player is able to connect, wherein the matchmaking process includes determining scores for active game instances executing on the game platform, the scores based on one or more characteristics of the active game instances and one or more corresponding characteristics of the requesting player, and selecting the active game instance that has the highest score to connect to the requesting player, and wherein the matchmaking process is skipped in response to finding the associated player reservation in the reservation map. In some implementations, the reservation map is a reservation index, wherein storing player reservations for the one or more players includes storing the player reservations in index entries of the reservation index, wherein the index entries respectively store references to the original game instances.

In some implementations, the method further includes allocating, by the at least one processor, prepared game instances for the game on one or more servers prior to completion of the update of the game, wherein the prepared game instances correspond to the original game instances of the game; and creating, by the at least one processor, one or more player slots in each of the prepared game instances, wherein the one or more player slots correspond to the one or more players, the reservation map maps the one or more player reservations to the one or more player slots of the prepared game instances, and the one or more updated game instances correspond to the prepared game instances. In some implementations, the one or more player slots are created in the prepared game instances such that each of the prepared game instances is allocated the same players as the corresponding original game instance.

In some implementations, the method further includes allocating, by the at least one processor, one or more extra prepared game instances for the game before or while the game is updating, wherein a total number of prepared game instances is allocated that is greater than the number of original game instances. In some implementations, the method further includes removing, by the at least one processor, at least one player reservation of the one or more player reservations from the reservation map if an expiration time has passed for the at least one player reservation before a request is received from a player associated with the at least one player reservation. In some implementations, the method further includes causing, by the at least one processor, the one or more players to disconnect from the original game instances and the game instances that are too close.

Some implementations may include a computer-implemented method that includes operations performed by a processor of a system described above. Some implementations may include a system that includes a processor and a memory coupled to the processor. The memory may have instructions stored thereon that, when executed by the processor, cause the processor to perform operations that include one or more of the features of the methods described above. Some implementations include a non-transitory computer-readable medium with instructions stored thereon that, when executed by a processor, cause the processor to perform operations that can be similar to features of the methods and/or systems described above.

### BRIEF DESCRIPTION OF THE DRAWINGS

FIG. 1 is a diagram of an example system architecture, in accordance with some implementations.

FIG. 2 is a block diagram of an example matchmaking system that can be used in an online gaming platform to determine a game instance for a requesting user, in accordance with some implementations.

FIGS. 3A and 3B are diagrammatic illustrations of example indexes that can be used to identify and track active game instances executing on a gaming platform, in accordance with some implementations.

FIG. 4 is a flow diagram of an example method to update game indexes in a matchmaking system with active game instances of a gaming platform, in accordance with some implementations.

FIG. 5 is a flow diagram of an example method to search indexes to determine one or more matched game instances in response to a user request to join a game a gaming platform, in accordance with some implementations.

FIG. 6 is a flow diagram of an example method to reserve player positions in game instances for a game update, in accordance with some implementations.

FIG. 7 is a flow diagram of an example method to reconnect players to game instances after a game update, in accordance with some implementations.

FIG. 8 is a block diagram illustrating an example computing device which may be used to implement one or more features described herein, in accordance with some implementations.

### DETAILED DESCRIPTION

One or more implementations described herein relate to an online game matchmaking architecture and techniques allowing improved matching of active online games (and other virtual experiences) to users who request to join a game. In some implementations, features can include providing an indexing module that maintains indexes of game instances that are relevant to requesting players and can be searched quickly in a matchmaking process. In some implementations, features can include techniques to provide improved reconnection of players to game instances after the game instances are closed for game updates.

Online gaming platforms (also referred to as “online metaverse platforms,” “user-generated content platforms,” or “user-generated content systems”) offer a variety of ways for users to interact with one another. For example, users of an online gaming platform may play games (or other virtual experiences) that are provided by the platform, e.g., games that include player-controlled characters (avatars), non-player characters (avatars), and other game objects and mechanisms. Some online gaming platforms can provide a variety of different environments (e.g., two dimensional or virtual three-dimensional environments) in which users can play online games. In some implementations, users of an online gaming platform may create games, other virtual experiences, or other content or resources (e.g., avatars, graphics, items for game play within a virtual world, etc.) within the gaming platform. Users of an online gaming platform may work together towards a common goal in a game or in game creation, share various virtual gaming items, send electronic messages to one another, and so forth. An online gaming platform may also allow users of the platform to communicate with each other, e.g., using voice messages (e.g., via voice chat), text messaging, video messaging, or a combination of the above.

In order to enhance the entertainment value of an online gaming platform, the platform can provide a matchmaking service. A user may input a request to the game platform to join a particular game (or other virtual experience), and the matchmaking service searches for and determines one or more game instances of the game that, at the time of the request, are suitable for the user to join. Suitable game instances may have one or more characteristics which are relevant to the requesting user. For example, a suitable game instance may be available for the user to join, e.g., have one or more open player slots and/or be waiting for one or more players to join, and has no restrictions that disqualify the user from joining (e.g., accepts any user to join, or the user has particular characteristics that are required to join the game instance). In some implementations, game instances can be scored for suitability for the requesting user based on one or more game instance characteristics, e.g., network communication speed (e.g., ping) or network communication latency. In some implementations, user and player characteristics can be searched by the matchmaking service, e.g., whether players in a game instance have a similar game skill level as the requesting user. Searched game instances can be scored by the matchmaking module based on the number of characteristics that match or are suitable to the user, and top (e.g., highest) scoring game instances are determined. In some example implementations, the user is automatically joined with the top scoring game instance, or multiple top scoring game instances are presented to the user who can select to join any of them.

However, in some game platforms, a matchmaking service may have many thousands of game instances to search and find matches for a player. Having to search a large number of game instances that are active on the game platform may cause delays in determining, presenting, and/or connecting game instances to users requesting to join games.

Furthermore, when a game of a game platform is updated (e.g., to fix bugs, add new features, etc.), the users playing in any game instances of that game are typically disconnected from the game instances to perform the update. Many of the disconnected users attempt to rejoin the updated game close in time after the update is complete, and many new users may also attempt to join the game due to, e.g., advertisement of the game update on the online gaming platform or in other communications, causing a large number of join requests to be received at the game platform. Resource expenditure and processing time may increase dramatically as the game platform attempts to fulfill all of the join requests. For example, a game platform may create many more game instances than is necessary, to accommodate the large number of user requests.

Features described herein provide improved and more efficient determination of eligible game instances (or other virtual experience instances) provided by a matchmaking service of an online gaming platform (or other system), as well as improved ability of a matchmaking service to rejoin players in games after game updates. Techniques are described that can reduce the amount of processing, use of network bandwidth, and delays in searching and determining matched game instances for a user. Described features thus provide technical advantages that allow reduction of use of computational resources (e.g., computer memory, processor, networking traffic, etc.) to find, present, and/or connect users to active game instances executing on a game platform.

In some examples, an indexing module can be used to index game instances in multiple indexes to reduce the query search space when searching for game instances for the matchmaking service. The indexing module can maintain a consistent copy of the identifications and game states of all game instances active on the game platform, which can be filtered relative to a primary game data store and organized for storage in particular indexes, e.g., cached in a minimalist lookup table or other data structure. Each index is associated with one or more particular game instance characteristics, and a subset of the indexes can be initially searched based on user characteristics of the requesting user that match (or are associated with) the game instance characteristics of the indexes. Thus, a subset of the game instances that is relevant to and associated with the requesting user can be initially searched without having to initially scan the entire list (or all indexes) of active game instances.

For example, the characteristics can include geographic location, such that game instances executing on a server device in the user's region are referenced in a subset of indexes that can be searched first. Indexes associated with other geographic regions can be searched (e.g., in a predetermined priority order) if no eligible game instances are found in the user's region indexes, or a new game instance can be initialized in the user's region in such a case. Thus, a set of eligible game instances that a user can potentially join can be found and provided efficiently for the matchmaking service. In contrast, previous matchmaking services typically scan all active game instances to determine which games are eligible for any user request to join a game, which increases the matchmaking processing time and thus the total time for a user to join a game instance, and causes additional consumption of network and processing resources. Furthermore, previous systems may scan a single data store to find active game instances for matchmaking, which may further increase the matchmaking decision time (and thus the total user join time) and may put read pressure on the data store compared to the use of multiple indexes as described herein.

Furthermore, in some implementations, indexing processing can be separated from matchmaking, thus reducing processing burden of matchmaking processes. For example, an indexing processor can obtain game state data from a game data stream and maintain the indexes independently of matchmaking processes.

Further, in some implementations, features described herein can reduce the time and resources expended to join users to game instances when a large number of users are disconnected from their game instances and a large number of these users request to re-join their instances within a short amount of time. For example, if a game is to be updated, a player reservation can be stored in a player reservation index for each player connected to an original game instance of that game, such that when the player is disconnected and requests to rejoin the game, the player reservation is accessed and the player is reconnected to an updated game instance having the same players and/or other characteristics of the original game instance. This avoids excess use of resources such as having to search for suitable game instances for a requesting user via matchmaking processes, and/or having to create more game instances than necessary to accommodate re-joining players.

As referred to herein, “active” or “currently executing” game instances on the game platform can include game instances that have active game sessions implementing gameplay (e.g., game instances in which players are currently active in the game environment), and/or game instances that are allocated and waiting to start (e.g., game instances which have not yet started, e.g., with one or more players having joined and waiting in a game queue or “lobby” for the game instance to start play).

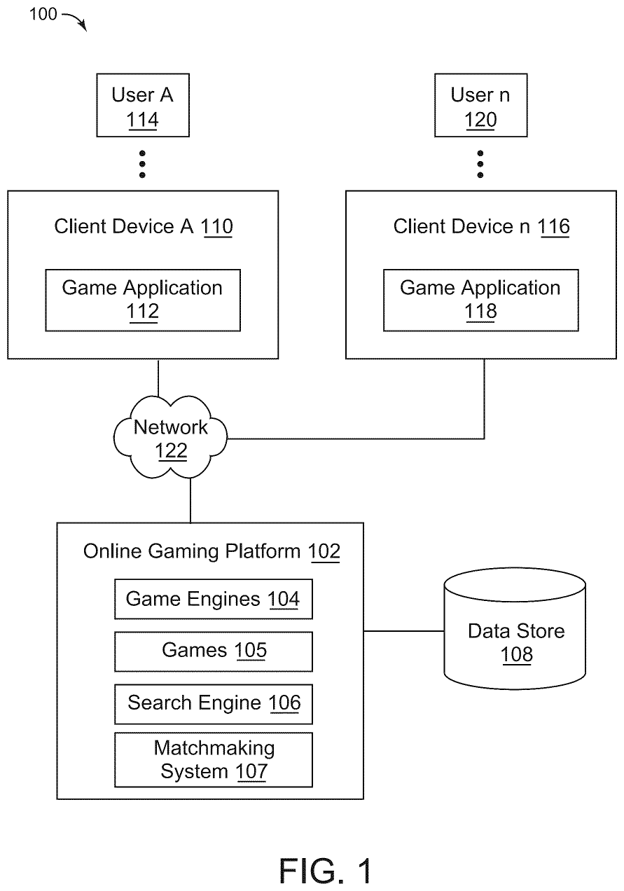

FIG. 1 illustrates an example system architecture 100, in accordance with some implementations of the disclosure. The system architecture 100 (also referred to as “system” herein) includes an online gaming platform 102, a first client device 110 (generally referred to as “client devices 110/116” herein), a network 122, and a second client device 116. The online gaming platform 102 can include, among other things, a game engine 104, one or more games 105, a search engine 106, a matchmaking system 107, and a data store 108. The client device 110 can include a game application 112. The client system 116 can include a game application 118. Users 114 and 120 can use client devices 110 and 116, respectively, to interact with the online gaming platform 102.

The term “game,” as used herein, refers to any virtual experience in a computer (virtual environment), including games with specified objectives or end states, as well as other types of games or virtual experiences provided for user(s) in a virtual environment such as training, tourism, activity simulation, concerts, meetings, virtual gatherings, etc. that may not have a specific objective or end state. The game or virtual experience may include one or more avatars (e.g., character models). An avatar is a virtual object that may be controlled by a human user, or may be a computer-generated avatar (e.g., a non-player character controlled by a game or other virtual experience). In various implementations, an avatar may be a humanoid, an animal form, a vehicle form, an object form, or any other form. In some implementations, the avatar may include a mesh (a set of points arranged in 3D space to obtain an avatar with body parts such as head, torso, limbs, etc.). Further, in some implementations, one or more textures may be attached to a mesh. The texture may define various visual appearances, such as avatar skin parameters, clothing parameters, etc., as color, reflectivity, shape, etc. In various implementations, avatar animation may be performed automatically by game engine 104 and/or by game applications (112, 118). A gaming platform, as described herein, may include any platform that provides one or more virtual experiences in a virtual environment or metaverse. A game application, as described herein, may include any application that enables a user to participate in a virtual experience such as a game, and engage in gameplay, including configuring an avatar, moving about in 3D space (of the virtual experience such as a game), performing actions, engaging with other avatars, interacting with other users via text/audio/video chat, etc.

System architecture 100 is provided for illustration. In some implementations, the system architecture 100 may include the same, fewer, more, or different elements configured in the same or different manner as that shown in FIG. 1.

In one implementation, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network), routers, hubs, switches, server computers, or a combination thereof.

In one implementation, the data store 108 may be a non-transitory computer readable memory (e.g., random access memory), a cache, a drive (e.g., a hard drive), a flash drive, a database system, or another type of component or device capable of storing data. The data store 108 may also include multiple storage components (e.g., multiple drives or multiple databases) that may also span multiple computing devices (e.g., multiple server computers).

In some implementations, the online gaming platform 102 can include a server having one or more computing devices (e.g., a cloud computing system, a rackmount server, a server computer, cluster of physical servers, virtual server, etc.). In some implementations, a server may be included in the online gaming platform 102, be an independent system, or be part of another system or platform.

In some implementations, the online gaming platform 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online gaming platform 102 and to provide a user with access to online gaming platform 102. The online gaming platform 102 may also include a website (e.g., one or more webpages) or application back-end software that may be used to provide a user with access to content provided by online gaming platform 102. For example, users may access online gaming platform 102 using the game application 112/118 on client devices 110/116, respectively.

In some implementations, online gaming platform 102 may be a type of social network providing connections between users or a type of user-generated content system that allows users (e.g., end-users or consumers) to communicate with other users via the online gaming platform 102, where the communication may include voice chat (e.g., synchronous and/or asynchronous voice communication), video chat (e.g., synchronous and/or asynchronous video communication), or text chat (e.g., synchronous and/or asynchronous text-based communication). In some implementations of the disclosure, a “user” may be represented as a single individual person. However, other implementations of the disclosure encompass a “user” (e.g., creating user) being an entity controlled by a set of users or an automated source. For example, a set of individual users federated as a community or group in a user-generated content system may be considered a “user.” In some implementations, a “user” can include one or more programs or virtual entities, and/or persons that interface with the system or network.

In some implementations, online gaming platform 102 may be a virtual gaming platform. For example, the gaming platform may provide single-player or multiplayer games to a community of users that may access or interact with games (e.g., user generated games or other games) using client devices 110/116 via network 122. In some implementations, games (also referred to as “video game,” “online game,” or “virtual game” herein) may be two-dimensional (2D) games, three-dimensional (3D) games (e.g., 3D user-generated games), virtual reality (VR) games or environments, or augmented reality (AR) games, for example. In some implementations, games can include environments which may not have game goals, e.g., simulators of particular actions or environments which a player can explore and/or interact with. In some implementations, users may search for games and participate in gameplay with other users in one or more games selected from results of the search. In some implementations, a game selected from results of the search may be played in real-time with other users of the game.

In some implementation, other collaboration platforms can be used with matchmaking features described herein instead of or in addition to online gaming platform 102. For example, a social networking platform, purchasing platform, messaging platform, creation platform, etc. can be used to match users to other users and/or platform features, functions, and services.

In some implementations, gameplay may refer to interaction of one or more players using client devices (e.g., 110 and/or 116) within a game (e.g., 105) or the presentation of the interaction on a display or other output device of a client device 110 or 116.

One or more games 105 are provided by the online gaming platform. In some implementations, a game 105 can include an electronic file that can be executed or loaded using software, firmware or hardware configured to present game content (including other virtual experience content) (e.g., digital media item) to an entity. In some implementations, a game application 112/118 of a game may be executed and one or more game instances can be rendered in connection with a game 105 and game engine 104. A game instance, as referred to herein, is a particular instance of a game 105 and associated game engine 104 that can implement a game session or play session involving a set of one or more players, where one or more users can connect to and join a game instance to interact with the game. Users that connect to and participate in a game instance (e.g., play the game in the game instance, or connect to a game instance to play the game when the game initiates) can be referred to herein as players of the game or game instance. Multiple game instances can be provided for a game 105, where each game instance can implement the same basic game code and rules (e.g., use the same game engine 104), and/or some of the game instances can implement different code and/or rules, e.g., if different game settings or options have been selected by one or more players. Each game instance can be joined by a different set of players and can be executed independently of the other game instances, e.g., events in one game instance can be independent of other game instances; or in some cases, multiple game instances can be linked such that one or more events can be synchronized in the linked game instances. Multiple game instances can be executed on one or more servers, e.g., each game instance can be executed on a server at a different geographic location. In some implementations, a game 105 may have a common set of rules and/or common goal, and the environments of a game share the common set of rules and/or common goal. In some implementations, different games 105 may have different rules or goals from one another.

In some implementations, games 105 may have one or more environments (also referred to as “gaming environments” or “virtual environments” herein) where multiple environments may be linked. An example of an environment may be a three-dimensional (3D) environment. The one or more environments of a game may be collectively referred to a “world” or “gaming world” or “virtual world” or “universe” herein. An example of a world may be a 3D world of a game. For example, a user may build a virtual environment that is linked to another virtual environment created by another user. An avatar of the virtual game may cross the virtual border to enter the adjacent virtual environment.

It may be noted that 3D environments or 3D worlds use graphics that use a three-dimensional representation of geometric data representative of game content (or at least present game content to appear as 3D content whether or not 3D representation of geometric data is used). 2D environments or 2D worlds use graphics that use two-dimensional representation of geometric data representative of game content.

In some implementations, the online gaming platform 102 can host one or more games 105 and can permit users to interact with the games 105 (e.g., search for, request, and/or join game instances of a game 105, game-related content, or other content) using a game application 112/118 of client devices 110/116. Users (e.g., 114 and/or 120) of the online gaming platform 102 may play, create, interact with, or build games 105, search for games 105, communicate with other users, create and build objects (e.g., also referred to as “item(s)” or “game objects” or “virtual game item(s)” herein) of games 105, and/or select or search for objects. For example, when generating user-generated virtual items, users may create avatars, decoration for the avatars, one or more virtual environments for an interactive game, or build structures used in a game, among others. In some implementations, users may buy, sell, or trade game virtual game objects, such as in-platform currency (e.g., virtual currency), with other users of the online gaming platform 102. In some implementations, online gaming platform 102 may transmit game content to game applications (e.g., 112). In some implementations, game content (also referred to as “content” herein) may refer to any data or software instructions (e.g., game objects, game, user information, video, images, commands, media item, etc.) associated with online gaming platform 102 or game applications. In some implementations, game objects (e.g., also referred to as “item(s)” or “objects” or “virtual game item(s)” herein) may refer to objects that are used, created, shared or otherwise depicted in games 105 of the online gaming platform 102 or game applications 112 or 118 of the client devices 110/116. For example, game objects may include a part, model, avatar or character, tools, weapons, clothing, buildings, vehicles, currency, flora, fauna, components of the aforementioned (e.g., windows of a building), and so forth.

It may be noted that the online gaming platform 102 is provided for purposes of illustration, rather than limitation. In some implementations, online gaming platform 102 may host one or more media items that can include communication messages from one user to one or more other users. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a game 105 may be associated with a particular user or a particular group of users (e.g., a private game), or made widely available to users of the online gaming platform 102 (e.g., a public game). In some implementations, where online gaming platform 102 associates one or more games 105 with a specific user or group of users, online gaming platform 102 may associate the specific user(s) with a game 105 using user account information (e.g., a user account identifier such as username and password).

In some implementations, online gaming platform 102 or client devices 110/116 may include a game engine 104 or game application 112/118. In some implementations, the game engine 104 can include a game application similar to game application 112/118. In some implementations, game engine 104 may be used for the development and/or execution of games 105. For example, game engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the game engine 104 may generate commands that help compute and render a game instance of the game 105 (e.g., rendering commands, collision commands, physics commands, etc.). In some implementations, game applications 112/118 of client devices 110/116, respectively, may work independently, in collaboration with game engine 104 of online gaming platform 102, or a combination of both.

In some implementations, both the online gaming platform 102 and client devices 110/116 execute a game engine (104, 112, and 118, respectively). The online gaming platform 102 using game engine 104 may perform some or all the game engine functions (e.g., generate physics commands, rendering commands, etc.), or offload some or all the game engine functions to game applications 112 and 118 of client devices 110 and 116, respectively. In some implementations, each game 105 may have a different ratio between the game engine functions that are performed on the online gaming platform 102 and the game engine functions that are performed on the client devices 110 and 116. For example, a game engine 104 of the online gaming platform 102 may be used to generate physics commands in cases where there is a collision between at least two game objects, while the additional game engine functionality (e.g., generate rendering commands) may be offloaded to the client device 110. In some implementations, the ratio of game engine functions performed on the online gaming platform 102 and client device 110 may be changed (e.g., dynamically) based on gameplay conditions. For example, if the number of users participating in gameplay of a game 105 exceeds a threshold number, the online gaming platform 102 may perform one or more game engine functions that were previously performed by the client devices 110 or 116.

For example, players may be playing in a game instance of game 105 on client devices 110 and 116, and may send control instructions (e.g., user inputs, such as directional inputs of right, left, up, down, avatar position and velocity information, text, voice input, etc.) to the online gaming platform 102. Subsequent to receiving control instructions from the client devices 110 and 116, the online gaming platform 102 may send gameplay instructions (e.g., position and velocity information of the avatars participating in the group gameplay or commands, such as rendering commands, collision commands, etc.) to the client devices 110 and 116 based on control instructions. For instance, the online gaming platform 102 may perform one or more logical operations (e.g., using game engine 104) on the control instructions to generate gameplay instruction for the client devices 110 and 116. In other instances, online gaming platform 102 may pass one or more or the control instructions from one client device 110 to other client devices (e.g., 116) participating in the game instance. The client devices 110 and 116 may use the gameplay instructions and render the gameplay for presentation on the displays of client devices 110 and 116.

In some implementations, the control instructions may refer to instructions that are indicative of in-game actions of a user's avatar. For example, control instructions may include user input to control the in-game action, such as right, left, up, down, user selection, gyroscope position and orientation data, force sensor data, text, voice input, etc. The control instructions may include avatar position and velocity information. In some implementations, the control instructions are sent directly to the online gaming platform 102. In other implementations, the control instructions may be sent from a client device 110 to another client device (e.g., 116), where the other client device generates gameplay instructions using the local game application 118. The control instructions may include instructions to play a voice communication message or other sounds from another user on an audio device (e.g., speakers, headphones, etc.).

In some implementations, gameplay instructions may refer to instructions that allow a client device 110 (or 116) to render gameplay of a game in a game instance, such as a multiplayer game. The gameplay instructions may include one or more of user input (e.g., control instructions), avatar position and velocity information, or commands (e.g., physics commands, rendering commands, collision commands, etc.).

In some implementations, avatars (or game objects generally) are constructed from components, one or more of which may be selected by the user, that automatically join together to aid the user in editing. One or more avatars (also referred to as a “character” or “model” herein) may be associated with a player where the player may control the avatar to facilitate the player's interaction with the game 105. In some implementations, an avatar may include components such as body parts (e.g., hair, arms, legs, etc.) and accessories (e.g., t-shirt, glasses, decorative images, tools, etc.). In some implementations, body parts of avatars that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools. In some implementations, a player may control the scale (e.g., height, width, or depth) of an avatar or the scale of components of an avatar. In some implementations, the player may control the proportions of an avatar (e.g., blocky, anatomical, etc.). It may be noted that is some implementations, an avatar may not include an avatar game object (e.g., body parts, etc.) but the player may control the avatar (without the avatar game object) to facilitate the player's interaction with the game (e.g., a puzzle game where there is no rendered avatar game object, but player user still controls an avatar to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish a user's avatar for view or use by other users of the online gaming platform 102. In some implementations, creating, modifying, or customizing avatars, other game objects, games 105, or game environments may be performed by a user using a user interface (e.g., developer interface) and with or without scripting (or with or without an application programming interface (API)). It may be noted that for purposes of illustration, rather than limitation, avatars are described as having a humanoid form. In may further be noted that avatars may have any form such as a vehicle, animal, inanimate object, or other creative form.

In some implementations, the online gaming platform 102 may store avatars (e.g., characters) created by users in the data store 108. In some implementations, the online gaming platform 102 maintains an avatar catalog and game catalog that may be presented to users via a user interface. In some implementations, the game catalog includes images of games stored on the online gaming platform 102. In addition, a user may select an avatar (e.g., a character created by the user or other user) from the avatar catalog to participate in the chosen game. The avatar catalog includes images of avatars stored on the online gaming platform 102. In some implementations, one or more of the avatars in the avatar catalog may have been created or customized by the user. In some implementations, the chosen avatar may have avatar settings defining one or more of the components of the avatar.

In some implementations, a user's avatar can include a configuration of components, where the configuration and appearance of components and more generally the appearance of the avatar may be defined by avatar settings. In some implementations, the avatar settings of a user's avatar may at least in part be chosen by the user. In other implementations, a user may choose an avatar with default avatar settings or avatar setting chosen by other users. For example, a user may choose a default avatar from an avatar catalog that has predefined avatar settings, and the user may further customize the default avatar by changing some of the avatar settings (e.g., adding a shirt with a customized logo). The avatar settings may be associated with a particular avatar by the online gaming platform 102.

In some implementations, the client device(s) 110 or 116 may each include computing devices such as personal computers (PCs), mobile devices (e.g., laptops, mobile phones, smart phones, tablet computers, or netbook computers), network-connected televisions, gaming consoles, etc. In some implementations, a client device 110 or 116 may also be referred to as a “user device.” In some implementations, one or more client devices 110 or 116 may connect to the online gaming platform 102 at any given moment. It may be noted that the number of client devices 110 or 116 is provided as illustration, rather than limitation. In some implementations, any number of client devices 110 or 116 may be used.

In some implementations, each client device 110 or 116 may include an instance of the game application 112 or 118, respectively. In one implementation, the game application 112 or 118 may permit users to use and interact with online gaming platform 102, such as search for a game or other content, control a virtual avatar in a virtual game hosted by online gaming platform 102, or view or upload content, such as games 105, images, video items, web pages, documents, and so forth. In one example, the game application may be a web application (e.g., an application that operates in conjunction with a web browser) that can access, retrieve, present, or navigate content (e.g., virtual avatar in a virtual environment, etc.) served by a web server. In another example, the game application may be a native application (e.g., a mobile application, app, or a gaming program) that is installed and executes local to client device 110 or 116 and allows users to interact with online gaming platform 102. The game application may render, display, or present the content (e.g., a web page, a media viewer) to a user. In an implementation, the game application may also include an embedded media player (e.g., a Flash® player) that is embedded in a web page.

According to aspects of the disclosure, the game application 112/118 may be an online gaming platform application for users to build, create, edit, upload content to the online gaming platform 102 as well as interact with online gaming platform 102 (e.g., play games 105 hosted by online gaming platform 102). As such, the game application 112/118 may be provided to the client device 110 or 116 by the online gaming platform 102. In another example, the game application 112/118 may be an application that is downloaded from a server.

In some implementations, a user may login to online gaming platform 102 via the game application. The user may access a user account by providing user account information (e.g., username and password) where the user account is associated with one or more avatars available to participate in one or more games 105 of online gaming platform 102.

In general, functions described in one implementation as being performed by the online gaming platform 102 can also be performed by the client device(s) 110 or 116, or a server, in other implementations if appropriate. In addition, the functionality attributed to a particular component can be performed by different or multiple components operating together. The online gaming platform 102 can also be accessed as a service provided to other systems or devices through appropriate application programming interfaces (APIs), and thus is not limited to use in websites.

In some implementations, online gaming platform 102 may include a search engine 106. In some implementations, the search engine 106 may be a system, application, or module that permits the online gaming platform 102 to provide search functionality to users, where the search functionality permits the users to search games 105 that are available, the most popular games, game instances that are looking for players, game assets available on the gaming platform 102, etc.

Online gaming platform 102 includes a matchmaking module 107. Module 107 is used to provide game instances to a requesting user that may be appropriate for the user to join, based on one or more attributes of the user. For example, the user may input a request to the gaming platform to be presented with games 105 that the user can currently join. The request can also include a search term for, or specification of, a particular game 105 available on the platform 100 that the user desires to join.

Matchmaking system 107 can search for game instances in response to the game platform 100 receiving a request from a user to join a game at or soon after the request is received. These can be game instances that, at the time of the request, allow one or more players to join those instances, e.g., are active (executing) at the time of the user join request (currently active). In some examples, the currently active game instances can be implementing the game such that one or more other players are currently playing the game and one or more other players can join the game instance. In further examples, currently active game instances can implement queues or game lobbies where one or more players are waiting for one or more other players to join the game instance that will cause the game instance to initiate gameplay.

Matchmaking system 107 can employ a matchmaking process to determine which eligible (available) game instances currently executing on the game platform 100 are a match for the requesting player. In some implementations, currently active game instances can be indexed in a plurality of indexes associated with different game instance characteristics, which allow a subset of game instances to be efficiently scanned and their characteristics obtained. Matchmaking system 107 can determine scores for scanned game instances based on game instance characteristics of the game instances compared to one or more player characteristics or attributes of the player. In some implementations, matchmaking system 107 can find top scoring game instances, and one or more of those game instances can be presented to the user with the option to join any of them or the player can be automatically joined to a top scoring game instance. In some implementations, matchmaking system 107 can store player reservations of players connected to a game instance so that the players can quickly re-join similar game instances after a game update. Matchmaking system 107 can output determined matched game instance(s) which can be presented to the user and/or the user can be connected to a matched game instance. Further example details of matchmaking system 107 are described below.

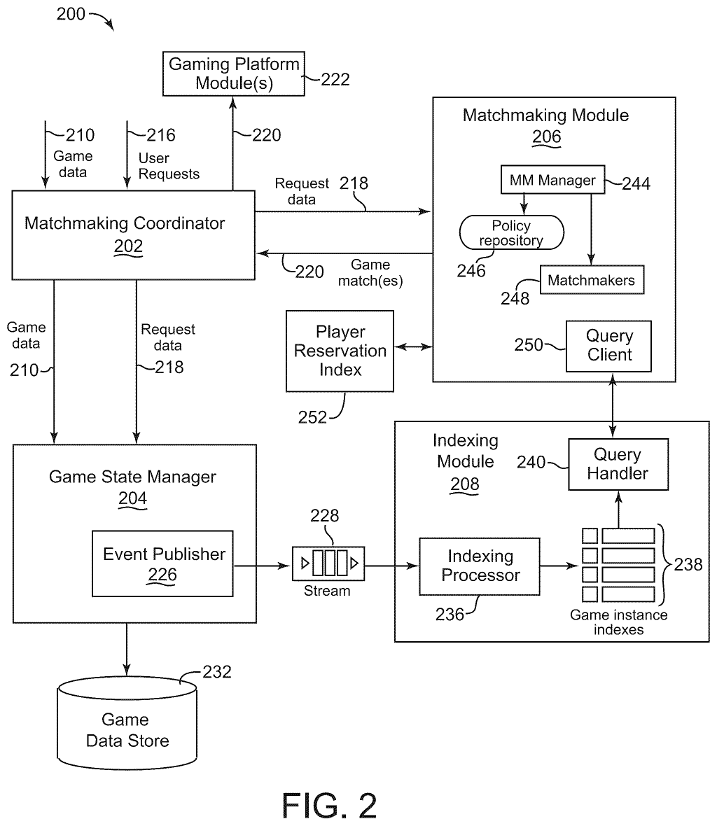

FIG. 2 is a block diagram illustrating an example matchmaking system 200 that can be used in an online gaming platform to determine a game instance for a requesting user, in accordance with some implementations. For example, matchmaking system 200 can be, or include, matchmaking system 107 of the online gaming platform 102 as shown in FIG. 1. In the example implementation of FIG. 2, matchmaking system 200 can include a matchmaking coordinator 202, a game state manager 204, a matchmaking module 206, and an indexing module 208.

Matchmaking system 200 can search for available, currently active game instances in response to receiving a request from a user to join a game. These can be game instances that, at the time of the request, allow one or more users to join those instances. In some examples of currently active game instances, one or more players may be currently playing in the game instance and one or more users can join the game instance as players, or one or more players are waiting for one or more other players to join the game instance that will cause the game instance to initiate gameplay.

In some implementations, matchmaking coordinator 202 receives several inputs from components of the game platform and outputs to other components of the matchmaking system 200. For example, coordinator 202 can coordinate incoming requests from users to the matchmaking system that request to join one or more matching game instances of the gaming platform. Coordinator 202 can control routing of information between various system components.

In some implementations, coordinator 202 can receive game data 210 from the gaming platform, which can include various types of information related to game instances. For example, game data 210 can include data from various game servers that are currently implementing game instances and/or are organizing players for a game instance. For example, game data 210 can include game state data including identifications of active game instances, a number of players and/or a list of identifications of players connected to each active game instance, length of active play sessions in the game instances, performance of servers executing the game instances (e.g., processor usage for each game instance, processing time or delays, etc.), and other game state data. In some implementations, game data is received periodically by the coordinator 202, e.g., every 30 seconds or other specified time period. Game data 210 can also include game state changes that may occur at any time and not occur regularly or periodically, e.g., in response to occurrence of game events including player actions, etc. For example, game state data can include indications of game events, e.g., players joining or exiting game instances, changes in game instances related to administrator commands (e.g., a player getting kicked out of a particular game instance), and/or indications that particular games are to be updated that cause game instances of those games to be closed, updated, and re-executed in updated states. In some implementations, coordinator 202 can send game data 210 to game state manager 204, including game state data and other game data.

In some implementations, coordinator 202 can also receive user requests 216, which indicate user requests to join (participate in) particular games that are indicated in the requests 216. Each user request 216 can be provided by a respective user device of the respective requesting user (e.g., a client device 110 to 116 of FIG. 1). Coordinator 202 sends game request data 218 to game state manager 204 based on the user requests 216. Coordinator 202 also can send the request data 218 to matchmaking module 206 to request and obtain one or more game matches 220 associated with each user request to join a game. Coordinator 202 can output obtained game matches to other components of the game platform. For example, coordinator 202 can output game matches 220 to one or more game platform modules 222 that can send information to user devices, connect a requesting user to a game instance indicated by the game matches (e.g., a top game instance in a ranked order of game instances), and/or cause a list of game matches to be sent to and presented by the user device of the requesting user from which the user can select a game instance to join.

In some implementations, game state manager 204 manages game state data and outputs the data for other components of matchmaking system 200. For example, in some implementations, game state manager 204 can include an event publisher 226. Game state manager 204 can receive game state data 210 and game request data 218 from coordinator 202. As described above, the game state data can include lists of players in game instances executing on the game platform and other game states, and game request data 218 indicates pending requests from users to join particular games offered on the game platform.

Event publisher 226 obtains the game state data 210 and game request data 218 (and/or data derived from data 210 and 218 by components in game state manager 204) to determine game event data to output. In some implementations, game state manager 204 outputs game event data in a game data stream 228. For example, event publisher 226 can output game data 210 and game request data 218, and/or other data derived from data 210 and 218, as game event data in stream 228. Game state manager 204 can output game state data in stream 228 that is used to maintain game states of game instances in indexes of the indexing module 208.

Game state manager 204 also can output game data 210 and request data 218 to a game data store 232 (e.g., via event publisher 226 or other component of the game state manager). The game data store 232 can store the game state data, other game data, game request data, and all other data relating to players and active game instances on the game platform. In some implementations, the game data sent to game data store 232 can include more data (and/or more types of data) than the game data output in game state stream 228. For example, only game state data relative to game states of games executing on the game platform can be included in game state stream 228 while game data store 232 can store all that game state data as well as other data, e.g., user related data, system/network status and operation data, etc. In other implementations, additional data can be sent in game state stream 228 to indexes 238, e.g., if the matchmaking module or process can utilize them. For example, in some implementations the matchmaking module can include network status in matchmaking determinations, e.g., to avoid slow networks or latency, and thus indexes 238 can be provided with network status data in game state stream 228.

Data store 232 can be accessed by game state manager 204 and, in some implementations, other components (e.g., matchmaking module 206) to obtain game states, player information, and/or other related game data for game instances, as needed. In some implementations, game state manager 204 can be responsible for handling fallback scenarios by accessing data store 232 if event publisher 226 fails to publish the game data stream 228.

Indexing module 208 receives game event data from game state manager 204, e.g., in the game data stream 228 or directly from game state manager 204, and organizes at least some of the game event data into multiple indexes that can be scanned to find game instances when matching games to user requests to join games. For example, an indexing processor 236 can receive the game event data from game data stream 228, filter out game event data that is not relevant to the indexes 238, and store data in indexes 238 (which can alternatively be considered game instance candidate pools). Indexes 238 can be provided in a data structure, such as a lookup table or database. Indexing processor 236 filters out some game data from the game event data such that indexes 238 collectively store a first subset of the game data stored by game data store 232, and each index 238 may store a different subset of the first subset of game data based on one or more game instance characteristics associated with each index (described below). For example, indexing processor 236 can remove game data received in the game data stream 228 that is not relevant to searching for active game instances, such as indications that particular game instances are closing, or are full of players and not available to be joined by requesting players. Such game instances are not available for the requesting user to join.

Indexes 238 in the data structure are maintained to store references to all currently active game instances on the gaming platform which are available for one or more users to join. The references can include entries in the data structure (e.g., lookup table) that each identify and correspond to a particular game instance. In some implementations, the indexes can also store game data related to the game instances, e.g., indications of one or more game states of those game instances (e.g., number of players connected to the game instance, player identifications of the players, duration of active play session, etc.). Such game data can be stored in or associated with the entries of the associated game instance identifications. The indexes can be organized to efficiently group the game data in different indexes so that the data is efficiently scanned for use by the matchmaking module, e.g., so that the data of all active game instances does not need to be scanned when searching for potential game instances for a user to join. For example, when retrieving game instances for a request from the matchmaking module for a particular user or user request 218, the indexing module 208 can initially scan indexes that are associated with characteristics that match user characteristics of the requesting user, and send those game instances to the matchmaking module for use in matching game instances to users. If one or more such indexes do not store identifications of eligible game instances, then one or more other indexes can be scanned (e.g., indexes associated with characteristics at a next higher priority level in a ranking of characteristics).

In some implementations, each index 238 can be associated with one or more characteristics of game instances which can be prominent in matchmaking decisions made by the matchmaking module 206. For greater efficiency, indexes 238 provide a reduced amount of game data for scanning as determined by indexing processor 236 that adds only particular game instances to each index 238. In some examples, matchmaking decisions by the matchmaking module may be based, in part, on the geographical regions in which a user and game instance server are located. Each index 238 can be associated with a game instance characteristic that is a geographical region in which the server(s) implementing the game instance are located. For example, if a first index is associated with a first geographical region, game instances located in that first region can be referenced in the first index. Similarly, game instances located in a second geographical region can be referenced in a second index associated with the second region.

In some implementations, individual indexes 238 can each be associated with multiple game instance characteristics, e.g., a first index can be associated with Region 1 and a first player age group (e.g., ages 13-18), and a second index can be associated with Region 1 and a second, different age group (e.g., ages 18-24). In some implementations, a particular game instance can be referenced by multiple indexes. For example, a particular game instance can be referenced in a first index associated with the geographical region of the particular game instance and by a second index associated with the age group of player(s) in the particular game instance.

Indexes can be dynamically created in the data structure based on particular game instance characteristics that exist in currently active game instances as indicated in the game data stream 228. For example, if game instances are currently active in geographical Regions 1 and 2 and not in Region 3, then indexes 238 can be created for Regions 1 and 2 and not created for Region 3. Indexes can be dynamically created based on one or more other events on the gaming platform, e.g., a particular user logging onto the game platform, entering a game instance, etc.

In further examples, indexes 238 can also or alternatively be associated with other game instance characteristics, such as language spoken by players connected to the game instance, age group of such players, occupancy of a game instance (e.g., how many player slots are available in a game instance for users to join, or how many users are currently connected to a game instance), or voice chat ratio (e.g., a ratio of the number of players who have enabled, are using, or are connected to voice chat features during the game instance, to the total number of players in the instance, which can be a matching criterion for the requesting user, e.g., if the requesting user has voice chat features enabled or prefers to use voice chat in instances).

In further examples, indexes can be created that are associated with a game instance characteristic that is a user social network on the gaming platform (e.g., as stored by the gaming platform). For example, if a social network includes Users 1, 2, and 3, and any of these users are playing in game instance(s), an index can be created dynamically and associated with that social network. References to game instances are added to that index if any of the players in those game instances are members of that social network. In some implementations, indexes 238 can similarly be associated with a characteristic that is a list of preferred users associated with a particular user. An index associated with the list can be dynamically created to store references to active game instances that include any of those preferred users. For example, if a list for a particular user includes Users 4, 5, and 6, and the particular user logs onto the gaming platform, an index can be dynamically created and associated with the particular user's list of preferred users. References to game instances are added to that index if any of those preferred users (Users 4, 5, 6) are playing in those game instances. Such preferred users can be, for example, designated friends or users that the particular user has historically played games with.

In some implementations, indexes 238 can be dynamically created based on other game instance characteristics, e.g., a geographical distance of a server implementing a game instance to a user device of a user, or a latency between the server and the user device. In some implementations, indexes can be associated with preferences of users, e.g., game types preferred by particular users (as indicated by user preferences or by a history of games played by the user on the gaming platform), where the game types can include types of games such as competitive/cooperative games, solitaire/multiplayer games, game genre types, etc.

In some implementations, one or more machine learning models can be trained and used to create indexes specific to particular user preferences or characteristics.

The indexes can be scanned when the matchmaking module requests game instances for a user request for the associated user to join a game, as described below.

In some implementations, the indexes can be split among different storage units of the gaming platform (e.g., “index shards”), where an index associated with a particular game instance characteristic can be replicated on multiple shards. Each replicated index can be associated with the same game instance characteristics but stores references to different game instances, e.g., game instances that are implemented locally to the shard on which the index is stored. For example, an index associated with a characteristic of player ages 20-24 can be provided on a first shard and store references to game instances 1 and 2, and a replica index associated with the same player ages can be provided on a second shard and store references to game instances 3 and 4.

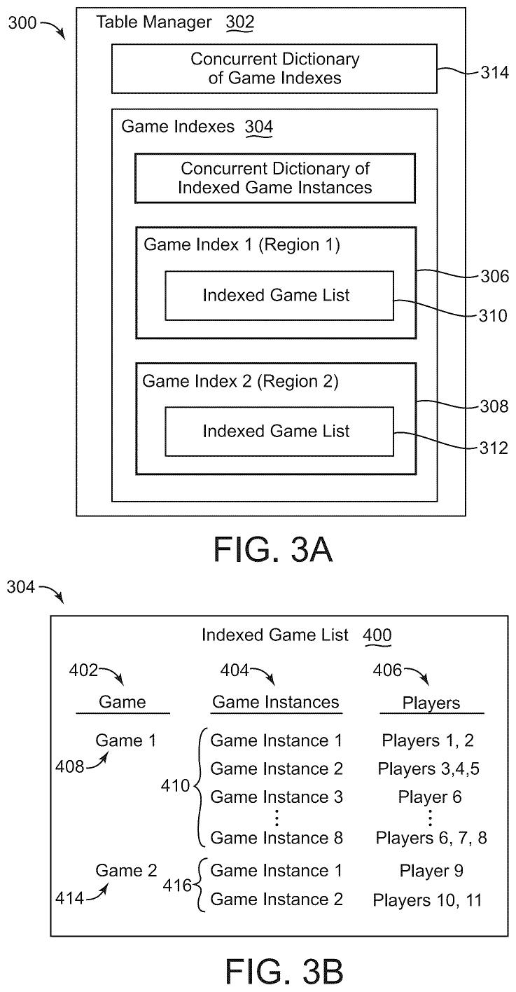

Some example implementations of indexes 238 are described below, e.g., with respect to FIGS. 3A and 3B.

In some implementations, the processes implemented by indexing processor 236 can be implemented separately from matchmaking processes implemented by matchmaking module 206 (and/or processors implementing such processes), which may reduce processing burden on the matchmaking module 206. Furthermore, in some implementations, a separate indexing processor 236 can handle pre-computation with indexing algorithms by polling from game data stream 228 and publishing filtered events to one or more indexes 238. This can decouple game event publishing in data stream 228 from indexing processing and other components of the matchmaking system 200/game platform that may use data from the game data stream 228. In addition, this can relieve a read burden on the game data store 232, e.g., compared to implementations that do not use the game data stream 228 and read game data from data store 232 for indexing or for searching for game instances.

In some implementations, instead of (or in addition to) obtaining game event data from the game data stream 228, the indexing module 208 can scan the game data store 232 (e.g., periodically or in response to a particular condition) and fetch the latest game states for any or all game instances to be indexed in indexes 238. In some implementations, this operation may create a read burden on the data store 232 that is undesirable, e.g., may cause duplicate scanning of data store 232 when multiple indexes obtain data for the same game instance.

In some implementations, a query handler 240 can be included in indexing module 208 to interface with matchmaking module 206. The query handler can represent a data access interface for reading from the indexes 238 stored in the data structure of indexing module 208. Query handler 240 can receive a request from matchmaking module 206 (e.g., via query client 250) for active game instances, fetch identifiers of active game instances from selected indexes of indexes 238 (and/or associated game data for those game instances), determine eligible game instances from the fetched game instances that match the request from the matchmaking module, and send the eligible game instances to the matchmaking module. Query handler 240 can include, in some implementations, an API controller that handles requests from the query client 250/matchmaking module 206, and accesses the data structure (e.g., calls a lookup table manager) to fetch eligible game instances from indexes 238. In some implementations, the selected indexes from which the query handler fetches game instances can be indicated by the query client of the matchmaking module in a query for the game instances, as described below.

Matchmaking module 206 determines game instances that match a request of a user to join a game, as indicated by the user request 216.

In some implementations, matchmaking module 206 can include a query client 250 that can be called as a library or other module within the matchmaking module 106. Query client 250 can include logic to interface with query handler 240 of indexing module 208, e.g., build and send queries to the query handler to obtain identifications of active game instances from the indexes 238. The indexes of the indexing module can be organized based on game instance characteristics, such that the retrieval of candidate game instances is much quicker than when scanning all of the active game instances (e.g., as stored in the game data store 232).

In some implementations, query client 250 (or other component of matchmaking module 206) can determine and select which of the indexes 238 to search for game instances, and send the selected indexes 238 to query handler 240 in a query. For example, the query client can obtain user characteristics of the requesting user from the matchmaking module, e.g., based on user request 216 received by matchmaking module 206 and/or based on information related to the requesting user that is stored by the gaming platform (e.g., user preferences and settings, history of user participation in games if user has consented, etc.). In some implementations, for greater efficiency, the query client (and/or query handler 240) can select indexes to search that have the lowest latency (e.g., indexes that are all stored in the same physical server, etc.). In some implementations, the query client can transform the request and selected indexes in the query into a more condensed object that is sent to the query handler, for greater communication efficiency.

In some implementations, query client 250 (and/or query handler 240) can access a mapping of user characteristics to indexes to determine which indexes to search. Each index is mapped to a user characteristic based on a game instance characteristic associated with the index. Indexes selected to be searched are associated with game instance characteristics that match the user characteristics of the requesting user as indicated by the mapping. For example, if the requesting user is located in Region 1 and thus has a region characteristic of Region 1, the query client (and/or query handler 240) determines to search one or more indexes that are associated with Region 1 as indicated in the mapping.

In some implementations, the mapping of user characteristics to indexes can include priorities assigned to the indexes. Indexes that have the same type of game instance characteristic can have different priorities, and the indexes are searched in the order of the listed priorities. In some implementations, indexes of a next lower priority level are searched if at least a threshold number of candidate instances are not found in the indexes of the previous, higher priority level. For example, all indexes are first scanned that are associated with a particular game instance characteristic and have priority 1 (the highest priority). If a threshold number of eligible game instances are not found in those indexes, indexes associated with that game instance characteristic and have priority 2 are scanned, and so on. In some examples, a set of indexes is associated with a geographical region characteristic. The mapping maps each user region to one or more indexes in that set of indexes and includes a priority level for each index in the set. In some examples, for a user characteristic of a North American region, the mapping assigns priority 1 to indexes that are located in North American regions, and assigns lower priorities to indexes that are located in regions further away from North America, since it is preferred that the requesting user join a game instance close in distance to the user device to reduce network communication time.

In some implementations, the query client can specify, in its query to the query handler, user characteristics and/or game characteristics of indexes to be searched. The query handler of indexing module 208 can access the above-described mapping to determine the particular indexes 238 to scan, e.g., scan indexes 238 in an order based on the priorities indicated in the mapping.

Based on the query from query client 250, query handler 240 fetches references to (e.g., identifications and/or game data for) a set of candidate game instances from indexes 238. In some implementations, query handler 240 processes the set of candidate game instances to remove ineligible game instances from the set (e.g., duplicate game instances, etc.). Query handler 240 sends the set of candidate game instances to the query client for processing by matchmaking module 206.

Matchmaking module 206 hosts one or more matchmaking processes that perform scoring of the candidate game instances received from indexing module 208, to determine one or more matching game instances for the requesting user. In some implementations, matchmaking module 206 can include a matchmaking manager 244, policy repository 246 that stores matchmaking policies accessible by the matchmaking manager 244, and/or one or more matchmaker modules 248 that examine a set of candidate game instances and determine matches of game instances to user join requests based on one or more characteristics of the game instances and the requesting users. For example, matchmaking manager 244 can access one or more policies from repository 246 that determine which characteristics are to be used in the matching of game instances to user requests performed by matchmakers 248.

In some implementations, matchmaking module 206 can match candidate game instances to user requests based on any of a number of game instance characteristics and user characteristics of the requesting user. In some implementations, one or more of the characteristics used to determine the match can be similar to the characteristics used to index game instances in particular indexes. For example, the game instance characteristics can include the occupancy of the game instance, e.g., the number of empty player slots available in the game instance for users to join (e.g., the greater the occupancy, the better the match if a game platform policy is to join users to more populated game instances; or the greater the number of slots available, the better the match if players are desired to be joined to low-population game instances). The game instance characteristics can include the number of players in the game instance that are in the social network of the user or preferred player list of the user; the network ping or latency for communication between the server of the game instance and the user device of the user; the geographic distance between the server of the game instance and the user device (e.g., geographic region of the server); the language used by players that are in the game instance compared to the language used by the requesting user; the age group (e.g., based on mean or average age) of the players that are in the game instance compared to the requesting user's age (where a user age within the age group provides a stronger match).

Other characteristics can also be used to determine matches, such as the skill level of players connected to the game instance compared to the requesting user's skill level (where skill levels can be determined based on, e.g., historical data such as win/loss or other performance metrics for previous sessions of the game played by the players and the requesting user). In further examples, general game preferences of the requesting user (e.g., stored by the game platform) can be evaluated for each candidate game instance to determine matching candidate game instances, e.g., game preferences such as number of players, type of game genre, competitive/cooperative game types, real time or turn-based games, etc.

In some implementations, the matchmaking module 206 can score each of the game instance characteristics for a particular candidate game instance, e.g., based on the presence of a characteristic (e.g., the game instance is in a preferred category of the user) or the degree that a characteristic is present (e.g., a degree of occupancy of the game instance by players), and/or based on a match between game instance characteristic and corresponding user characteristic (e.g., a non-zero score is assigned if there is a match, or a zero score is otherwise assigned). The scores of the individual game instance characteristics can be combined (e.g., weighted, summed, or otherwise processed) to obtain a total score for that candidate game instance. In some implementations, a candidate game instance can be scored based on a number of matching characteristics between the game instance and the requesting user. Each of the candidate game instances received from indexing module 208 can be scored similarly. The candidate game instance(s) having the highest score(s) can be provided by the matchmaking module as game matches for a user request, e.g., via matchmaking coordinator 202.

In some implementations, one or more of the matched game instances can be sent to the user device of the requesting user and presented to the user with the option to join any of them. For example, each game instance, the players currently connected to that game instance (e.g., playing the game or waiting in a game instance lobby), and other related information (e.g., duration of game instance, etc.) can be presented on the user device. The user can select one of the matched game instances and the gaming platform connects the user to the selected game instance, e.g., via game platform module(s) 222. Alternatively, the user device of the requesting user can be automatically connected to the top scoring (e.g., highest scoring) game instance of the matched game instances determined by the matchmaking module.

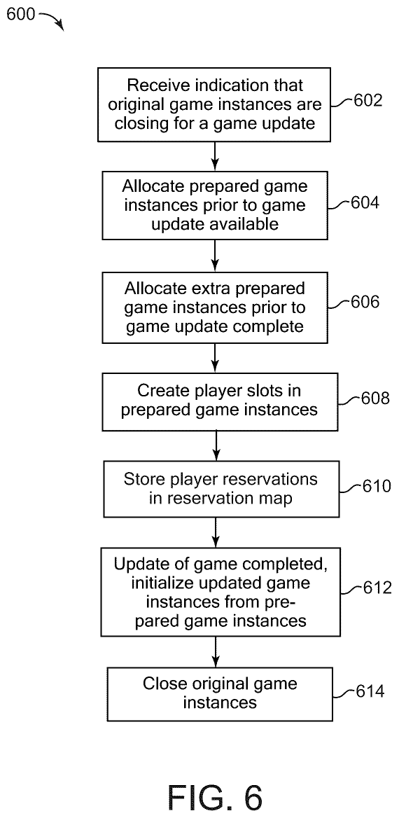

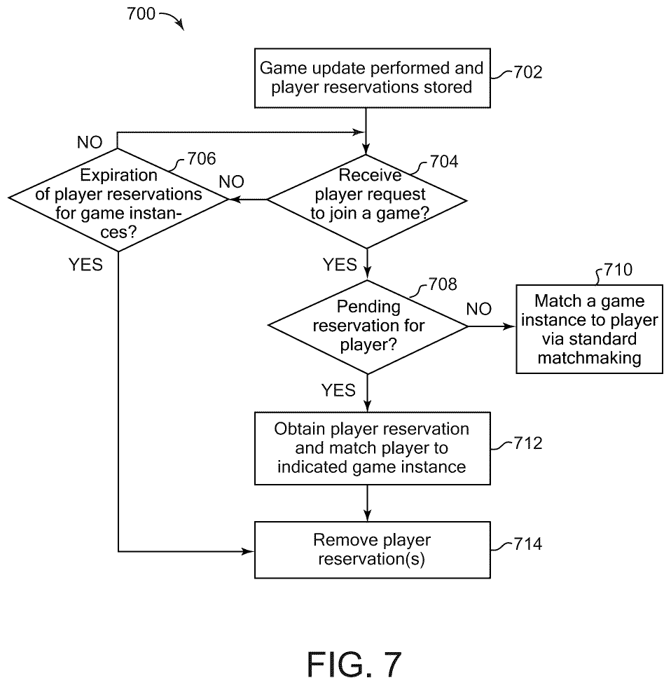

A player reservation index 252 can be used in some implementations. In some implementations, matchmaking module 206 (or other component of matchmaking system 200 or the game platform) can write player identifications to player reservation index 252 to store player reservations in game instances that are closed for game updates. Players associated with stored player reservations can quickly re-join similar game instances initiated after a game update. Some example implementations using a player reservation index are described below with respect to FIGS. 6 and 7. In some implementations, player reservation index 252 can be included in indexing module 208.

In some implementations, matchmaking system 200 can execute user matching to game instances on different nodes and data replicas, scale these replicas independently, and build caching and indexes for faster matchmaking processes. For example, another matchmaking module can be executed on a data replica to evaluate impact and load testing on the matchmaking system, and a history of game data (e.g., game states) can be sent to an external datastore for analysis for improving matchmaking system performance.

FIGS. 3A and 3B are diagrammatic illustrations of example indexes that can be used to identify and track active game instances executing on a gaming platform, in accordance with some implementations. For example, these indexes can be stored and continuously updated by indexing module 208 of matchmaking system 200 of FIG. 2 to allow searching of active and eligible game instances to which a requesting user can join. The use of the indexes allows a reduced set of game instances to be initially searched that are relevant to the requesting user, thus reducing expenditure of processing resources.

FIG. 3A shows an example lookup table 300 that can store indexes 238 of an indexing module, e.g., as shown in FIG. 2, according to some implementations. Lookup table 300 stores identifications of active game instances that can be searched to match a user request to join a game. In some implementations, lookup table 300 can be stored in memory of one or more devices of the gaming platform for fast access, or can be stored in other types of storage.

In the example of FIG. 3A, lookup table 300 can include a table manager 302 that can manage the lookup table, e.g., read and write operations to the lookup table as instructed by other components in the indexing module 208. Such operations can include, for example, scanning game indexes and retrieving game instance identifications and/or game data from scanned indexes, removing (closing) indexed game instance entries, removing one or more groups of game instances that are duplicated in the lookup table, finding one or more game indexes and adding new game instance entries to those indexes, updating one or more game instance entries with new game data such as a change in the players connected to the game instance, etc.

Game indexes 304 are a collection of indexes, where each index is a data structure that maintains an array of game instances that are currently active on the game platform and which are eligible for one or more players to join. Each index of indexes 304 lists a subset of the active game instances that have been filtered from the entire set of active game instances based on one or more game instance characteristics that are associated with the index as described herein. Each index 304 can be assigned an index identification which can be used as a key into the index. For example, in the example of FIG. 3A, an index 306 is assigned an index identification of Game Index 1 and is associated with a game instance characteristic of geographic region of the game instance. Index 306 stores eligible game instances which are active on servers located in a particular geographic region named Region 1. An index 308 is assigned an index identification of Game Index 2, is also associated with a game instance characteristic of geographic region, and stores eligible game instances which are active on servers located in a different geographic region named Region 2.

Each game index 304 stores an indexed game array (e.g., list) that includes eligible game instances that have one or more game instance characteristics associated with that index. For example, game index 306 (Game Index 1) includes an indexed game list 310 that includes game instances that are active on servers in Region 1. Similarly, game index 308 (Game Index 2) includes an indexed game list 312 that includes game instances that are active on servers in Region 2. Each game instance in these indexes has one or more open player slots for a player to join the game instance (some ineligible game instances, such as game instances having no available player slots, have been previously filtered and thus are not stored in indexes 304). Some examples of indexed game lists are described below with respect to FIG. 3B.

In some implementations, table manager 302 can maintain and access a concurrent dictionary 314 of game indexes. The dictionary can include entries for eligible game instances, e.g., storing game instance identifications and/or game data related to those game instances. Dictionary 314 can provide a list of game indexes 304 that can be quickly scanned and accessed by table manager 302 to determine which indexes are stored in table 300. In some implementations, dictionary 314 can provide a list of all eligible game instances executing on the game platform, at least a subset of which are included in the game indexes 304. For example, all the active game instances referenced in such an implementation can be quickly scanned by table manager 302 or other component, e.g., to determine whether a particular game instance is currently active and/or is currently indexed in the lookup table 300.

In some implementations, lookup table 300 can be organized into multiple partitions, where each partition includes a set of game indexes 304 that have related indexing characteristics and/or are grouped in the partition based on one or more other characteristics or criteria. For example, all of the game indexes 304 that reference game instances based on geographical region can be included in one partition, game indexes 304 that index based on another characteristic (e.g., social group, age group, etc.) can be included in a different partition, etc. In some implementations, an index of such partitions can be provided for access by the table manager 302 (not shown).

In some implementations, table manager 302 can manage the atomicity and synchronization of writes to lookup table 300, e.g., for multiple writes to the same index 304 or for writes of the same game instance to multiple indexes 304.

In some implementations, table manager 302 can periodically traverse all of the game instance entries in game indexes 304 and remove entries that reference game instances that no longer include any player identifications, which are game instances to which no players are currently connected. In some implementations, table manager 302 can remove game instance entries individually when receiving an indication or instruction to remove a player from a game instance (e.g., the instruction provided by indexing processor 236 based on game data stream 228 of FIG. 2) and determining that the game instance no longer includes any players. In some implementations, table manager 302 can remove game instance entries when informed that the game associated with the game instance entries is closed (e.g., shut down by a game developer or administrator, etc.).

FIG. 3B shows an example game index 304 that includes an indexed game list (or array) 400, according to some implementations. In some examples, game index 304 can be a game index in lookup table 300 of FIG. 3A, e.g., game index 306 or 308.

Indexed game list 400 can include a number of games 402, and each game 402 can have one or more game instances 404 to which players can connect. Each game instance is listed in indexed game list 400. For example, a game instance identification of each game instance can be stored in the indexed game list 400. Each game instance has one or more players 406 currently connected to the game instance. For example, game instances 410 can be created for a particular game 408 (Game 1), where each game instance executes the game 408 for a respective set of players 406 that have joined that game instance (e.g., a set of Players 1 and 2, a set of Players 3, 4, and 5, etc.). In this example, eight game instances 410 are provided for game 408. Similarly, a particular game 414 (Game 2) can have game instances 416 which each execute game 414 for a respective set of players.

In some implementations, additional information can also be stored in indexed game list 400. Each game instance 404 can have associated game data, such as game state information, stored in the index, e.g., in an entry associated with the game instance entry. For example, the game data can include identifications of players 406 that are currently playing the game instance (and/or a total number of these players). In the example of FIG. 3B, the list 400 can indicate that Player 1 and Player 2 (player identifications) are playing in Game Instance 1 (a game instance identification); Player 3, Player 4, and Player 5 are playing in Game instance 2; etc. In some cases, this information can be accessed, for example, by table manager 302 or other system component to determine whether any game instances are empty of players, and if so, to remove the empty game instance entries from the index. In some implementations, the table manager can determine whether any game instances are full of players (and thus not available to be joined by any new players) and remove them from lookup table 300. In some implementations, a determination of whether a game instance is full can be performed prior to storing the game instance in lookup table 300, e.g., by indexing processor 236 based on the game states received in game data stream 228. In another example, indexing processor 236 can determine whether a game instance stored in lookup table 300 has become full of players based on game data stream 228, and if a game instance is full, sends an indication to the table manager 302 to remove that game instance from lookup table 300.

Other game data (including other game state information) can additionally or alternatively be stored in game indexes 304. In some implementations, a game version number can be stored for each indexed game instance (e.g., in a game data entry associated with the game instance entry) to indicate the current version of that game instance, and to determine whether an update should be applied to a game instance entry (e.g., if the update has a later version number than the stored version number for the indexed game instance). In some implementations, one or more pointers or references can be stored in the game index that reference related game data that is stored in other storage locations. In some implementations, a map can be stored for each game instance (e.g., in the same index as the game instance), the map indicating all indexes of the lookup table in which the game instance is stored. In some implementations, this map can be referenced to quickly find index entries of a particular game instance in all of the indexes of the lookup table, e.g., for removal or updates of game instance entries in the lookup table of the particular game instance. In some implementations, player reservations for player slots in game instances can be stored in indexes 304; such player reservations are described below with respect to FIGS. 6 and 7.

In some implementations, table manager 302 can compare new and previous sorted index assignments (if existing) to determine the differences in the index assignments, thus determining the particular game instances that should be added to or removed from indexes, as well as determining the indexes that receive such changes.

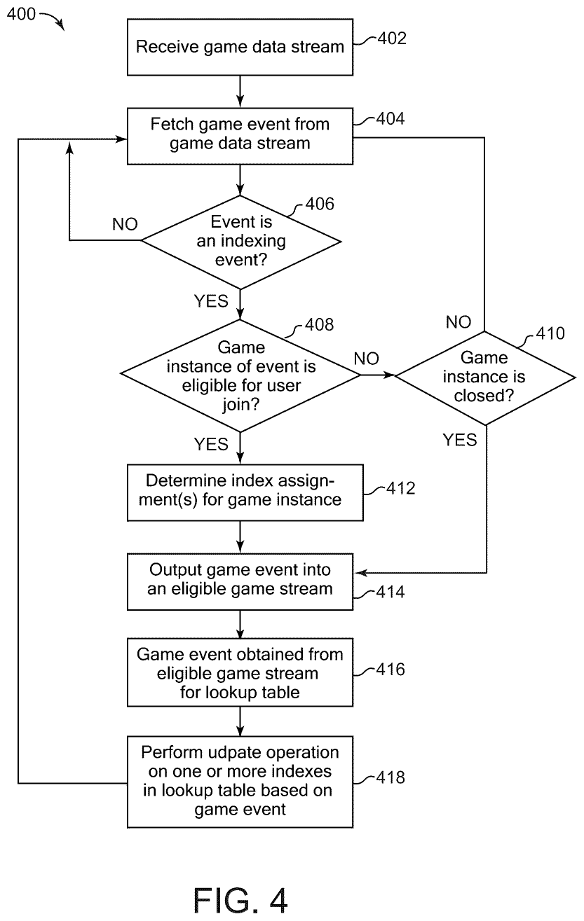

FIG. 4 is a flow diagram of an example method 400 to update game indexes in a matchmaking system with active game instances of a gaming platform, in accordance with some implementations. In some implementations, method 400 can be implemented, for example, on a server system, e.g., online gaming platform 102 as shown in FIG. 1. In some implementations, method 400 can be performed by an indexing module, e.g., indexing module 208 of the matchmaking system 200 of FIG. 2. In some implementations, some or all of the method 400 can be implemented on a system such as one or more client devices 110 and 116 as shown in FIG. 1, and/or on both a server system and one or more client systems. In described examples, the implementing system includes one or more processors or processing circuitry, and one or more storage devices such as a database, data structure, or other accessible storage. In some implementations, different components of one or more servers and/or clients can perform different blocks or other parts of the method 400.

In some implementations, method 400 can be implemented at least partially by indexing processor 236 of matchmaking system 200, or method 400 can be implemented in a different system. For example, indexing processor 236 can determine which game data from the game data stream 288 is to be stored in one or more indexes 238 of indexing module 208.

In block 402, a game data stream is received. In some implementations, such as the system 200 of FIG. 2, the indexing module 208 can receive game data stream 228 from game state manager 204 as described above. The game data stream includes game events that include game state changes that have occurred for game instances that are currently active on the game platform. In some implementations, the received game data is not provided in a stream, e.g., is received asynchronously based on event occurrence, is received at partially in parallel, etc. Block 402 may be followed by block 404.

In block 404, a game event is fetched from the game data stream. For example, the indexing processor 236 of indexing module 208 can poll the game data stream for particular data indicating the occurrence of game events. Such polled game events can be game state changes and game events can have any of various types including, for example, creation of a new game instance on the game platform, closing (e.g., removal) of a game instance, update of a game instance (e.g., the game instance is closed and a new game instance opened as an updated version, a player has joined or exited the game instance), etc. In some implementations, the game data stream provides serialized data, and the indexing processor can deserialize the game data stream to obtain game events. Block 404 may be followed by block 406.

In block 406, it is determined whether the fetched game event is an indexing event. In some implementations, indexing processor 236 can perform the determination. In some implementations, an indexing event is an event that causes one or more changes in game state that causes an update to one or more game instance indexes, e.g., an addition of one or more entries, modification to one or more entries, or removal of one or more entries in one or more game instance indexes. In some implementations, the determination of an indexing event can be based on the event type of the game event. For example, particular event types are considered indexing events, while other event types are considered ineligible. In some examples, eligible game events can include creation of a new game instance, closing or removal of an existing game instance, and updating of a game instance (where updating can include closing the game instance, updating the game code, and opening or initiating an updated game instance). In these examples, other types of game events can be considered ineligible for indexing.

If the game event is determined to not be an indexing event in block 406, the method continues to block 404 to fetch another game event from the game data stream to process that event as described above.

If the game event is determined to be an indexing event in block 406, the method continues to block 408, in which it is determined whether the game instance in which the game event occurred is eligible to be joined by a user that requests to join a game instance. In some implementations, the eligibility of user join can be determined based on the status of the game instance. In some examples, the game instance can be ineligible to be joined if the game event indicates that the game instance is closed or is pending for closure (e.g., the game event is a closed game event caused by all players exiting the game instance or the game instance being closed by an administrator of the game platform). A game instance that has a status of private (instead of a status of public) can be considered ineligible to be joined by a user (e.g., when the matchmaking system 200 is being used to find game instances that are available to any user, not game instances that are only available to particular users). A game instance that is full of players and has no available slots for additional players is ineligible to be joined by a user. A game instance that is designated as (temporarily or permanently) prohibited or banned in some form (e.g., by an administrator) for general users is considered ineligible to be joined by a user.

If the game instance is determined as ineligible to be joined by a user in block 408, the method continues to block 410, in which it is determined whether the game instance associated with the game event is closed or is pending for closure. If not, then the game event is not used for indexing and the method continues to block 404 to fetch another game event from the game data stream to process that event as described above. If the game instance of the event is closed or pending for closure, and/or the game event indicates this closure, then the game event may be used to modify one or more indexes, and the method continues to block 414, described below.

If the game instance is determined as eligible to be joined by a user in block 408, the method continues to block 412, in which one or more index assignments are determined for the game instance that are associated with the game event. For example, the index assignments can include one or more update operations associated with the type of the game event, where an update operation modifies index entries of one or more indexes as described below (e.g., writing, modifying, or deleting identifications of the game instance and/or related game data of the game instance).

The index assignments specify or target particular indexes which are to be updated. For example, the targeted particular indexes can be associated with one or more game instance characteristics that match game characteristics of the game instance. The one or more particular indexes are a subset of all the active game instance indexes that store references to the active game instances, where the subset is less than the number of those active game instance indexes. For example, if one or more indexes are associated with a game instance characteristic that is a particular geographical region where servers executing game instances are located, then an index assignment can target the particular index(es) associated with the same region where the game instance is executing. If a first index is associated with this geographical region and a second index is associated with another characteristic that is a particular language used by players of game instances in that index, and the game instance is associated with that same player language, then index assignments can target both the first index and the second index for updating. Block 412 may be followed by block 414.

In block 414, in some implementations, the game event (and/or the index assignments) are output to be used in modifying one or more indexes. In some implementations, indexing processor 236 can serialize the game event in an eligible game stream that is output to other components of the indexing module 208 such as an agent of the data structure (e.g., lookup table) that stores the indexes. In some implementations, the indexing processor can publish eligible game events in any of multiple eligible game streams, and each eligible game stream is provided to a different storage unit, e.g., an associated respective index shard. Each index shard can store replicas of indexes (associated with the same game instance characteristics) that store references to different game instances, and multiple shards can be accessed simultaneously to obtain indexes faster. For example, each shard can store a fraction of the data, so they can be faster to index and look up than when not using such shards, and they can reduce the pressure of memory consumption by each shard.

In some implementations, the indexing processor can output the game event directly to update the lookup table and not in an eligible game stream; in some implementations, such direct communication may create a greater burden on the indexing processor to handle such communication compared to outputting an eligible game stream that allows agent(s) of lookup tables to handle some processing. Block 414 may be followed by block 416.

In block 416, the game event output in block 414 is obtained for use in modifying the lookup table, e.g., obtained from the eligible game stream output in block 414. For example, an agent associated with a lookup table can obtain the game event and deserialize it (if needed). In some implementations, the agent can be associated with a particular index shard, and multiple agents can receive the eligible game stream for processing; in some implementations, each agent can be associated with only one respective index shard. Block 416 may be followed by block 418.

In block 418, an update operation is performed on one or more indexes in the lookup table based on the game event obtained in block 416. In some implementations, the update operation can be performed on multiple indexes. In some implementations, one update operation can update only one index shard. In some examples, the lookup table agent obtains the index assignments for the game instance associated with the game event (as determined in block 412, e.g., by indexing processor 436) and performs the update operation on the appropriate indexes based on those index assignments and the type of the game event.

For example, if the type of game event is a creation of a game instance, the update operation includes creation of an entry that includes a reference to the newly-created game instance, the entry being created in the appropriate index(es) indicated by the index assignments. In some implementations, one or more associated game states of the newly-created game instance can also be stored in the index(es) (e.g., the number of current players in the game instance and associated player identifications, time of creation of game instance, geographical region of server, etc.).

In further examples, if the type of game event modifies an existing game instance, the update operation includes updating the entry for the existing game instance in the index(es) based on the game event, the entry being located in appropriate index(es) as indicated by the index assignments. For example, if the game has been updated, the update operation can include writing a new version number of the game instance in the index entries and/or updating other game data in the index entry, if appropriate. In some implementations, new and previous index assignments can be compared to determine which indexes for the game instance should be updated; in some of these implementations, index assignments are provided in a sorted order (e.g., based on order of index entries or other order) so that new and previous index assignments can be readily compared. In another example, if the type of game event closes a game instance, the update operation includes removing corresponding entries for the closed game instance from the appropriate indexes indicated by the index assignments.

In some implementations, the agent or other processor or process associated with the lookup table can also periodically traverse all the indexes in the lookup table and remove entries or other table portions if no active game instances correspond to those portions.

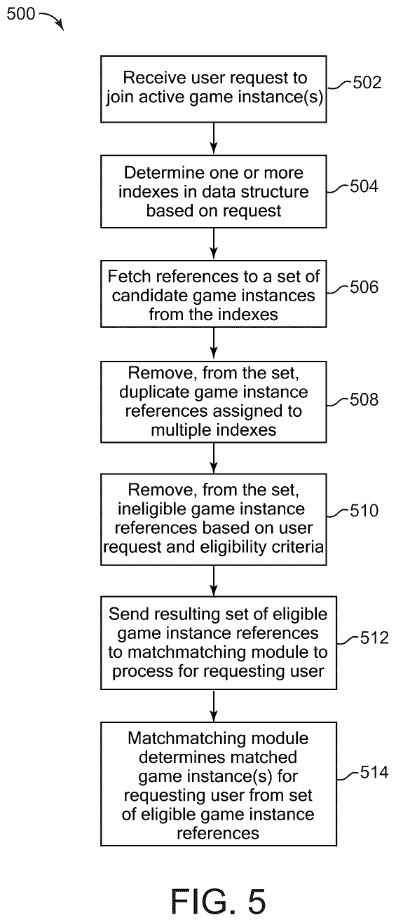

FIG. 5 is a flow diagram of an example method 500 to search indexes to determine one or more matched game instances in response to a user request to join a game a gaming platform, in accordance with some implementations. In some implementations, method 500 can be implemented, for example, on a server system, e.g., online gaming platform 102 as shown in FIG. 1. In some implementations, some or all of the method 500 can be implemented on a system such as one or more client devices 110 and 116 as shown in FIG. 1, and/or on both a server system and one or more client systems. In described examples, the implementing system includes one or more processors or processing circuitry, and one or more storage devices such as a database or other accessible storage. In some implementations, different components of one or more servers and/or clients can perform different blocks or other parts of the method 500.

In some implementations, method 500 can be performed after game instance references are stored in indexes of a matchmaking system, e.g., as described above with reference to FIG. 4. The indexes store indications of the active game instances (and eligible to be joined by a user) on the game platform such that only a subset of game instances are initially searched by the querying of method 500, allowing faster determination of matching game instances by the matchmaking module due to initially scanning a smaller set of game instances than if the entire set of game instances is scanned.

In some implementations, method 500 can be implemented by query client 250 of matchmaking module 206 and query handler 240 of indexing module 208, as described for matchmaking system 200 of FIG. 2, or method 500 can be implemented in a different system. For example, query client 250 can receive a request from the matchmaking module and can interface with query handler 240 to obtain a list of candidate game instances that the matchmaking module can further process to provide matched game instances and/or a game instance connection to the requesting user.

In block 502, a user request is received that requests identification of (or connection to) one or more game instances that are currently active on the game platform, and which are available for a requesting user to join. In some implementations, the request is provided by a component (e.g., matchmaking manager) of matchmaking module 206 to query client 250. Other components of the matchmaking system 200 can alternatively be used. The request can identify the user that is requesting to join an active game instance. Block 502 may be followed by block 504.

In block 504, one or more indexes are determined in the lookup table (or other data structure, e.g., database) based on the request received in block 502. In some implementations, query client 250 can determine the indexes. For example, query client 250 can have access to a mapping of user characteristics to particular indexes that store game instances having game instance characteristics that match those user characteristics. In some examples, the mapping can include a number of different geographical regions of users, and indicates the index(es) that are mapped to each of those user regions. The mapped indexes store references to game instances on servers within geographical regions that are the same as their mapped user regions. Search priorities assigned to indexes can also be stored in the mapping, as described above.

In further examples, mappings can map other user characteristics to indexes associated with corresponding game instance characteristics, e.g., languages used by the user and players in game instances, age groups of the user and players, social group networks of the user and players, game preferences of the user, etc., as described elsewhere herein. One or more user characteristics of the requesting user can be used as a key to look up the particular indexes in the mapping. In some implementations, the characteristics of the requesting user can be obtained from a data store of the game platform (if user permission has been received), such as a key-value store, a user database, etc., and/or the user characteristics can be provided in a join request received by the query client 250 or other system component. In some implementations, query handler 240 can determine the indexes in block 504 instead of query client 250, similarly as described above. Block 504 may be followed by block 506.

In block 506, references to a set of candidate game instances are fetched from the indexes. For example, the references include identifications of the candidate game instances, and in some implementations the references can include other game data related to the candidate game instances (e.g., number of players currently joined in each game instance, game settings, etc.). In some implementations, the query handler 240 can receive the query and indexes determined in block 504 from the query client 250, or in other implementations, the query handler (or other processor) may have determined the indexes. In some implementations, multiple query handlers are provided, e.g., a handler at each index shard, and each handler receives the query and indexes from the query client and performs the fetch from indexes at their shard. The game instance references in the indexes are fetched by the query handler from the lookup table, e.g., by providing appropriate commands or calls to a table manager of the lookup table.

A subset of the indexes are thus searched to obtain candidate game instance references; this reduces lookup time compared to scanning an index referencing all active game instances on the game platform. In some implementations that use multiple index shards to store indexes, the query handler can determine from which shards to request indexes (e.g., based on identifications of the shards, which can be hashcodes based on the game, game instance, place within the instance, total number of shards, etc.), and the game instance references may be obtained from multiple shards; such game instance references can be combined into a single set of candidate game instance references.

In some implementations, if no candidate game instances are found in an index associated with matching characteristics of the requesting user, or if less than a threshold number of candidate instances are found, then one or more other indexes (e.g., having the same type of game instance characteristic(s)) can be searched. For example, if an index for a matching region of the requesting user does not have references to any candidate game instances or has less than the threshold number, an index for a different region can be searched for candidate game instances (e.g., a region that is closest to the player's region out of the available region indexes). In some implementations, the indexes can be assigned priorities (e.g., in the mapping) and the next highest priority index can be searched if a higher priority index has less than the threshold number, as described above.

In some implementations, if no candidate game instances are found in an index associated with matching characteristics of the requesting user, or if less than a threshold number of candidate instances are found, then a new game instance can be created to which the user can join, and the information for the new game instance can be added to one or more indexes, as described below. In some implementations, a new game instance can be created after a threshold number of additional indexes are searched (as described above) and less than the threshold number of candidate game instances are found in the indexes searched. Block 506 may be followed by block 508.

In block 508, duplicate game instance references are removed from the set of candidate game instance references fetched in block 506. For example, in some implementations, a reference to a game instance may be stored in multiple indexes, such as a geographic region index and a player language index. Any duplicates are removed from the set. In some implementations, the query handler can perform block 508. Block 508 may be followed by block 510.

In block 510, references to ineligible game instances are removed from the set of candidate game instance references that resulted from block 508, based on the user request and eligibility criteria. In some implementations, ineligible game instances include game instances that are ineligible for the requesting user, e.g., do not meet eligibility criteria. In some implementations, the eligibility criteria is related to the requesting user (and/or the user device of the requesting user). For example, ineligible game instances may have one or more players currently connected to them who are in a blocked list associated with the requesting user (e.g., designated by the requesting user or determined based on input from the requesting user), which may be instances the user does not want to join. In some examples, ineligible game instances are not included in particular categories of games designated by the requesting user (e.g., as determined by stored preferences or settings associated with the requesting user). In some examples, ineligible game instances do not meet other user-specified or user-associated criteria (e.g., voice chat enabled or disabled in the instance, language spoken by players, age group of players, bandwidth or network performance between requesting user's device and the device executing the instance, etc.). Some or all of these criteria can be also or alternatively evaluated by the matchmaking module 206 as described herein. In some implementations, the eligibility criteria can include criteria that is general, e.g., not necessarily specifically related to the requesting user, such as particular game instance or game platform conditions that cause the game instance (or types thereof) to be temporarily ineligible (e.g., instance is full of players with no open slots, network performance, high (greater than a threshold) server load on the server that executes the game instance (e.g., network and/or processing load), game performance issues, instance is temporarily being shut down to migrate a new version of its engine code, etc.). In some implementations, the query handler can perform block 510. In some implementations, the eligibility filtering of block 510 can reduce the number of instances that are evaluated by the matchmaking module (e.g., in block 514) to enable faster performance and processing of method 500. Block 510 may be followed by block 512.

In block 512, a resulting set of eligible game instance references are sent to the matchmaking module to process for the requesting user. For example, in some implementations, query client 250 calls query handler 240 to fetch data, query handler 240 sends the set of eligible game instance references to query client 250, and query client 250 can provide the set to matchmakers 248 and/or other components of the matchmaking module 206 that queried for eligible instances. In some implementations, metadata related to eligibility filtering of blocks 508 and/or 510 and selected indexes can also be sent from the query handler to the query client. For example, such metadata can include game instance characteristics obtained from game data stream 228 and/or characteristics derived therefrom and/or stored in game instance indexes 238.

In some implementations, game state information associated with the set of eligible game instance references and obtained from the indexes (and associated metadata, if provided) can be transformed by the query handler into a concise object that includes only information that the matchmaking module 206 uses for scoring game instances when determining game instance matching to the requesting player. For example, game state information relating to matchmaking characteristics and player slot status can be included in the game object, and other game state information (if any) can be excluded from the game object. This transformation can reduce the amount of information sent to the matchmaking module, and reduce the cost of sending the information compared to sending all game states of the eligible game instances (or other game states not relevant to search and matchmaking processes described herein) over a network to the matchmaking module.

In block 514, the matchmaking module determines one or more matched game instances for the requesting user from the received set of eligible game instance references. In some implementations, the query client of the matchmaking module can receive the set of eligible game instance references from the query handler of the indexing module and can send the set to one or more other components of the matchmaking module 206, e.g., a matchmaking manager.

For example, the matchmaking module can use one or more matchmaking techniques or algorithms to determine one or more matched game instances, based on one or more matchmaking characteristics of the game instances. For example, the matchmaking module can, for each of the eligible game instances, individually score the game instance for each of the matchmaking characteristics, and then determine a total score by combining the individual scores. Such matchmaking characteristics can include the occupancy of the game instance (how many players are currently in the game instance), the language used by game players (e.g., based on how many players in the game instance speak the language of the requesting user), geographical distance of the game instance to the requesting user's device, ping time or network latency from the requesting user's device to the server of the game instance, how many players in the game instance are in the requesting user's age group, skill level of the players in the game instance compared to the requesting user's skill level, how highly the type of game instance is ranked for the requesting user on a personal ranked list of game types, etc. In some cases, one or more of these characteristics may have been used in indexing the game instances as described above such that the set of eligible game instances may have been at least partially filtered based on such characteristics. In some implementations, the matchmaking module can decline to apply such characteristics used in indexing the eligible game instances.

In some implementations, the eligible game instance that has the top (e.g., highest) score is selected as a matched game instance for the requesting player. In some implementations, the requesting user device is caused to automatically connect to the matched game instance, or the user device is connected after the user indicates consent. In some implementations, a list of the top ranked matched game instances are presented to the requesting user on the user device, the requesting user can select one of the presented game instances to join, and the user device is connected to the selected game instance.

In some implementations, if no candidate or eligible game instances are found to be a match to the requesting user (e.g., not found in selected indexes, or not eligible), a new game instance can be created for the requesting user and the requesting user can be connected to the new game instance. The game instance indexes can be updated appropriately with the new game instance information. For example, a reference to the new game instance (e.g., game instance identification and/or other related game data) can be added to the indexes that are associated with one or more user characteristics (e.g., the geographical region, language, etc. of the requesting user).

Various described features allow smaller, flexible, customized indexes to be created based on particular index and user characteristics to index game instances executing over an entire game platform, to provide a reduced search space for matchmaking features. In some implementations, a customized upper bound for eligible instances to be evaluated by the matchmaking module can be provided (to reduce required matchmaking processing by the matchmaking module) by periodic sampling of characteristics of executing instances and by filtering and/or pre-ranking executing instances based on metadata characteristics that are non-personalized (e.g., not associated with users), e.g., an instance that is full of players, has greater than a threshold server load, etc.; such filtering and pre-ranking can be performed by the index (e.g., indexing module 208) and use criteria that corresponds with filtering and ranking criteria used by the matchmaking module to determine game instance results. In some implementations, such filtering and pre-ranking can be performed at various times, e.g., during a server refresh time, at run time, etc.

FIG. 6 is a flow diagram of an example method 600 to reserve player positions in game instances for a game update, in accordance with some implementations. In some implementations, method 600 can be implemented, for example, on a server system, e.g., online gaming platform 102 as shown in FIG. 1. In some implementations, some or all of the method 600 can be implemented on a system such as one or more client devices 110 and 116 as shown in FIG. 1, and/or on both a server system and one or more client systems. In described examples, the implementing system includes one or more processors or processing circuitry, and one or more storage devices such as a database or other accessible storage. In some implementations, different components of one or more servers and/or clients can perform different blocks or other parts of the method 600.

In some implementations, method 600 can be implemented at least partially by a matchmaking module 206 of an indexing module as described for matchmaking system 200 of FIG. 2, or method 600 can be implemented in a different system. For example, the matchmaking module can store player reservations and receive user requests to rejoin game instances after a game is updated.

In some implementations, the closing of game instances for a game to be updated can be performed by a different component of the game platform than the matchmaking system, and this component can send indications to the matchmaking system as to the progress of the closing, updating, and restarting of the game and game instances.

In block 602, an indication is received that an update of the game is to be performed and/or that active game instances (e.g., “original game instances”) of a game are closing for the game update such that current players are to be disconnected from the original game instances for or during the update of the game. In various implementations, the matchmaking system receives this indication, or other components of the system. For example, a developer of the game or administrator of the game platform can send a command to the online gaming platform that an update is to be performed such that a new version of the game is published which has changes to the code of the game, and that game instances of old versions of the game that are currently executing are to be closed to enable updated game instances of the updated game to replace those game instances. In some implementations, the indication can be a “refresh” than may be periodically called from game instances or when players join or leave a game instance; for example, this refresh may cause the current game state of the instance to be sent from the instance engine to the matchmaking module, and in a returned response, the instance engine receives a signal to evict the player or close the game instance. Block 602 may be followed by block 604.

In block 604, prepared game instances are defined and/or allocated. In some implementations, these prepared game instances are defined and/or allocated prior to the updated game being available to users to join, e.g., prior to completion of the update to the game and in advance of the updated game being executed. For example, if the game update occurs in a time period of several minutes before the game is again available to players, the prepared game instances can be allocated within that time period. The prepared game instances correspond to the original game instances of the game, e.g., there are the same number of prepared game instances as original game instances. In some implementations, the prepared game instances are specified to execute on the same servers as their corresponding original game instances and are specified to have the same number of players as their corresponding original game instances. In some implementations, one or more resources can be defined and/or allocated for prepared game instances, e.g., memory or storage allocated on particular hardware servers, identifications of players stored for reference, etc.

In some implementations, the game update commences prior to or during block 604, e.g., by one or more components of the game platform. In various implementations, the game update can commence at a later time, e.g., after any block of method 600. In various implementations, the game update can include changing existing code of the game according to update instructions, or can include initializing and executing a different set of code that replaces the previous code of the game. Block 604 may be followed by block 606.

In block 606, extra prepared game instances are defined and/or allocated (e.g., on the same or additional servers). In some implementations, these prepared game instances are defined and/or allocated prior to the updated game being available to users to join, e.g., prior to completion of the update to the game and in advance of the updated game being executed, similarly to the prepared game instances of block 604. The extra prepared game instances can be allocated similarly as the prepared game instances of block 604. The extra game instances can be allocated as new instances, e.g., that need not correspond to any of the original instances. The extra game instances are allocated to enable requesting players to be accommodated in sufficient prepared game instances if additional players request to join the game after the update is completed. For example, a game update may become known by other players who were not previously playing in the original game instances, and the other players may request to join the game after the update is complete. In some implementations, the number of extra game instances to be allocated can be a percentage of the original game instances that existed prior to the game update, e.g., 5 or 10%. Block 606 may be followed by block 608.

In block 608, player slots are created in the prepared game instances. For example, the number of player slots that existed in the original game instances are allocated to the prepared game instances. In some implementations, each prepared game instance is provided with the same characteristics as its corresponding original game instance, such as number of player slots, game settings, etc. (some characteristics may not be the same if the game update changes or removes them).

In some implementations, a respective expiration time is also assigned to each prepared game instance. The expiration time indicates the time period after the game instance is initiated and made available to join by users (after the game update is complete) that the game instance will expire and automatically be removed if no user requests to join the game instance within that time period. Thus, if a user having a player reservation (see below) does not request to join the game instance before the expiration time passes, that player reservation is removed to allow any user to join the game instance in the player slot that was previously reserved. In some implementations, the expiration time can be customized based on the type of game update or based on previous cases of updating game instances. For example, a larger expiration time can be used for a new game engine or extensive update to an existing game, and a smaller expiration time can be used for a smaller, less extensive game update to an existing game. Block 608 may be followed by block 610.

In block 610, player reservations are stored in a player reservation map, e.g., a player reservation index, that maps players to the original game instances to which they were connected to prior to the game update. These are reservations of players in player slots of prepared game instances based on the corresponding original game instances. In some implementations, the player reservations can include a player identification and a game instance identification. For example, the player identification can include a player name and/or address of the player's device (network address, etc.). For example, the game instance identification can include a game server identification, index shard identification, and/or any other information used to identify the original game instance to which the player was connected. In some implementations, the player reservation map can be player reservation index 252 of FIG. 2. Block 610 may be followed by block 612 in some implementations.

In block 612, the update to the game that was previously commenced is completed, and updated game instances are initialized and executed for the updated game. Some of the updated game instances are initialized based on the prepared game instances of block 604 that have the same number of player slots, game and server settings, etc. as a corresponding original game instance that is closed (e.g., in block 614). These updated game instances are associated with mapped player reservations stored in the player reservation map. Some updated game instances are initialized from the extra prepared game instances of block 606 and are not associated with player reservations. In some implementations, an indication that the update of the game is complete and/or the updated game is starting, e.g., from a different component of the game platform, can be received by the matchmaking module. In some implementations, the matchmaking module can perform game updates and/or can initialize the prepared game instances as updated game instances on one or more game instance servers.

In block 614, the original game instances of the game are closed (e.g., execution discontinued) and the players in those game instances are disconnected from the original game instances. In some implementations, the closure of the original game instances can be performed after block 612. In some implementations, players removed from the closing instances can immediately join the updated instances after they are removed. In some implementations, the game platform components that perform the closing of the original game instances can be informed that the prepared game instances are allocated or executing before they close the original game instances. In some implementations, the closure of the original game instances can be performed after block 604, block 606, block 608, or block 610, e.g., after player slots are reserved for new updated instances.

In some implementations, requests to rejoin the original game instances may be received from players after they are disconnected from those instances, and in some implementations, such requests can be processed as described below with respect to FIG. 7. In some implementations, an automatic re-join request can be provided for each removed player to be joined to corresponding updated instances after they are removed from the original instances.

In various implementations, the blocks and/or operations in the blocks of method 600 can occur at any of various times and in various orders, and/or at least partially in parallel. For example, the timing of the original game instances being closed, updating of the game commencement and completion, and initialization of updated game instances can vary and may occur at different times during method 600 for updates of different games.

FIG. 7 is a flow diagram is a flow diagram of an example method 700 to reconnect players to game instances after a game update, in accordance with some implementations. In some implementations, method 700 can be implemented, for example, on a server system, e.g., online gaming platform 102 as shown in FIG. 1. In some implementations, some or all of the method 700 can be implemented on a system such as one or more client devices 110 and 116 as shown in FIG. 1, and/or on both a server system and one or more client systems. In described examples, the implementing system includes one or more processors or processing circuitry, and one or more storage devices such as a database or other accessible storage. In some implementations, different components of one or more servers and/or clients can perform different blocks or other parts of the method 700.

In some examples, method 700 can be performed after one or more blocks of method 600 have been performed, where method 600 stores player reservations for a game update. In some implementations, method 700 can be implemented at least in part by a matchmaking module 206 of an indexing module, as described for matchmaking system 200 of FIG. 2, or method 700 can be implemented in a different component or system.

In block 702, a game update is performed and player reservations are stored. In some implementations, these operations are performed as described above with reference to FIG. 6. For example, updated game instances for the updated game can be initialized from prepared game instances that are based on the original game instances of the game prior to the update, and the updated game instances are available for players of the game platform to join. Player identifications (and/or other player information) of players connected to original game instances of the game are stored in a player reservation map such as an index as described above. Block 702 may be followed by block 704.

In block 704, it is determined whether the matchmaking module receives a user request to join a game. If no user request is received, the method continues to block 706, in which it is determined whether expiration times of player reservations for one or more game instances has passed, e.g., such that the player reservations have expired. The one or more game instances include any updated game instances for which a game update was performed and player reservations were stored. Expiration of a player reservation indicates no player claimed the player reservation and joined the game instance associated with the expired player reservation before passage of the expiration time of that reservation. In some implementations, the expiration time may have been set when reserving player slots in the prepared game instances, e.g., in block 608 of FIG. 6, or a default expiration time period may be used. In some implementations, block 706 can be implemented after other blocks of method 700, in method 600, or at other times.

For player reservations that have not expired, the method continues to block 704 to continue to determine if a user request has been received to join a game. For player reservations that have expired, the method continues to block 714 as described below.

If a user request to join a game is received in block 704, then the method continues to block 708, in which it is determined whether there is a stored and pending player reservation for the requesting player. For example, in some implementations the player reservation may have been stored in the player reservation index in block 610 as described above. This index can be scanned in block 708 to determine if there is a reservation associated with the requesting player in the index, e.g., by scanning player identifications in the index for the requesting player's identification. If no player reservation for the requesting player is found, the method continues to block 710, in which a game instance is matched to the requesting player using standard matchmaking techniques. For example, the matchmaking system 200 can use one or more features described herein (e.g., as described in FIGS. 2-5) to find a matched game instance for the requesting player, and/or can use other matchmaking techniques.

If there is a player reservation for the requesting player as determined in block 708, then the method continues to block 712, in which player reservation information is obtained from storage, e.g., the player reservation index, and the requesting player is matched to the updated game instance indicated by the player reservation information. The indicated game instance corresponds to the original game instance that the requesting player was connected to prior to the game update. For example, the indicated game instance has the same game settings, the same number of players, the same identifications of players reserved to participate, etc. as the original game instance.

The requesting player can immediately be connected to the indicated game instance, or the requesting player can be provided a prompt to enable the user to confirm to be connected to the indicated game instance. Block 712 may be followed by block 714.

In block 714, one or more player reservations are removed from the player reservation index. For example, if a requesting player has a player reservation and was connected to a game instance indicated by the reservation in block 712, that player reservation is removed from the player reservation index. If one or more player reservations have expired as determined in block 706, those player reservations are removed from the player reservation index without any player having claimed them, thus allowing other players to join the associated game instances using those formerly-reserved player slots.

The described techniques in FIGS. 6 and 7 can reduce the resources expended in a matchmaking system when a large number of users are disconnected from original game instances and many or all of these players request to re-join the game (e.g., after the game is updated) within a short amount of time. In some implementations, a player reservation can be stored in the player reservation index for each player connected to an original game instance, such that when the player is disconnected and rejoins the updated game, the player reservation can be accessed and the player can be reconnected to an updated game instance that corresponds to the original game instance they were previously connected to, e.g., having the same game settings, the same players participating (if the same players have rejoined), etc. Thus, the same sets of players can be grouped in the same instances based directly on stored player reservations and without having to perform matchmaking computations for the players. In addition, these features avoid having to create a much larger number of game instances than necessary to accommodate a large number of players re-joining an updated game, which may be necessary in previous systems.

In various implementations, various blocks of methods 400, 500, 600, and/or 700 may be combined, split into multiple blocks, performed in parallel, or performed asynchronously. In some implementations, one or more blocks of these methods may not be performed or may be performed in a different order than shown in these figures. Methods 400, 500, 600, and/or 700, or portions thereof, may be repeated any number of times using additional inputs. For example, in some implementations, method 400 may be performed periodically and/or when one or more game instances are changed (opened, closed, updated, etc.). Method 500 may be performed in response to the matchmaking system receiving a user request to join a game. Method 600 may be performed in response to a game being updated, and method 700 may be performed in response to receiving a user request to join a game.

Various implementations as described herein are implemented with specific user permission for use of user data, e.g., user information, avatar data, etc. The user is provided with a user interface that includes information about how the user's information is collected, stored, and analyzed, and enables the user to control such use of the user's information. For example, the user interface requires the user to provide permission to use any information associated with the user. The user is informed that the user information may be deleted by the user, and the user may have the option to choose what types of information are provided for different uses. The use of the information is in accordance with applicable regulations and the data is stored securely. Data collection is not performed in certain locations and for certain user categories (e.g., based on age or other demographics), the data collection is temporary (i.e., the data is discarded after a period of time), and the data is not shared with third parties. Some of the data may be anonymized, aggregated across users, or otherwise modified so that specific user identity cannot be determined.

Various implementations described herein may include obtaining data relating to users, analyzing such data, and providing user interfaces. Data collection is performed only with specific user permission and in compliance with applicable regulations. The data are stored in compliance with applicable regulations, including anonymizing or otherwise modifying data to protect user privacy. Users are provided clear information about data collection, storage, and use, and are provided options to select the types of data that may be collected, stored, and utilized. Further, users control the devices where the data may be stored (e.g., user device only; client+server device; etc.) and where the data analysis is performed (e.g., user device only; client+server device; etc.). Data are utilized for the specific purposes as described herein. No data is shared with third parties without express user permission.

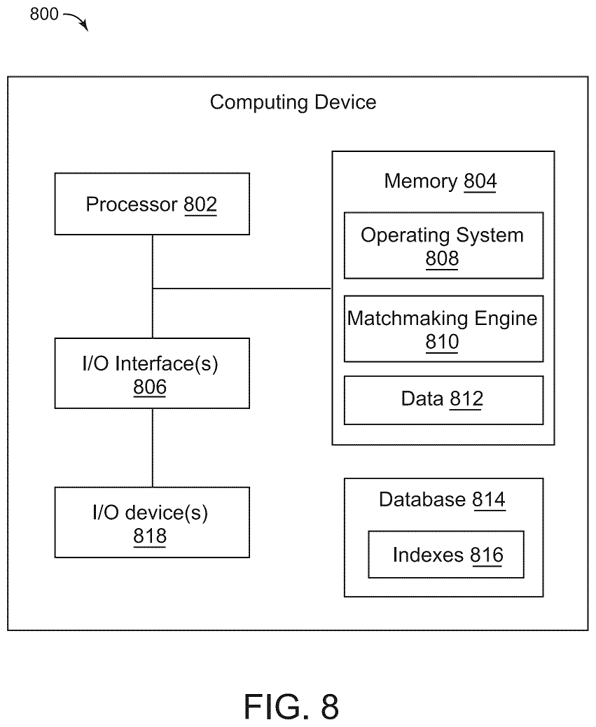

FIG. 8 is a block diagram of an example computing device 800 which may be used to implement one or more features described herein, in accordance with some implementations. In one example, device 800 may be used to implement a computer device (e.g., 102, 110, and/or 116 of FIG. 1), and perform appropriate method implementations described herein. Computing device 800 can be any suitable computer system, server, or other electronic or hardware device. For example, the computing device 800 can be a mainframe computer, desktop computer, workstation, portable computer, or electronic device (portable device, mobile device, cell phone, smart phone, tablet computer, television, TV set top box, personal digital assistant (PDA), media player, game device, wearable device, etc.). In some implementations, device 800 includes a processor 802, a memory 804, input/output (I/O) interface 806, and audio/video input/output devices 818 (e.g., display screen, touchscreen, display goggles or glasses, audio speakers, microphone, etc.).

Processor 802 can be one or more processors and/or processing circuits to execute program code and control basic operations of the device 800. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. In some implementations, processors 802 can include an indexing processor 236 as described above with reference to FIG. 2.

Memory 804 is typically provided in device 800 for access by the processor 802, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 802 and/or integrated therewith. Memory 804 can store software operating on the server device 800 by the processor 802, including an operating system 808, a matchmaking engine 810, and associated data 812. In some implementations, matchmaking engine 810 can include instructions that enable processor 802 to perform functions described herein, e.g., some or all of the methods of FIGS. 4 to 7.

In some implementations, database 814 can be provided to store various data used in processes described herein. For example, in some implementations, database 814 can include indexes 816, which can include the game instance indexes 238 of FIGS. 2, 3A and 3B. In some implementations, all or portions of indexes 816 can be stored in memory 804.

For example, memory 804 and/or database 814 can include software instructions for matchmaking engine 810 that can provide matchmaking and indexing features as described herein within an online gaming platform (e.g., 102). Any of software in memory 804 and/or database 814 can alternatively be stored on any other suitable storage location or computer-readable medium. In addition, memory 804 and/or database 814 can store instructions and data used in the features described herein, e.g., games and game instances, game state data, user and player data (with user consent), etc.). Memory 804, database 814, and any other type of storage (magnetic disk, optical disk, magnetic tape, or other tangible media) can be considered “storage” or “storage devices.”

I/O interface 806 can provide functions to enable interfacing the server device 800 with other systems and devices. For example, network communication devices, storage devices (e.g., memory and/or data store 108), and input/output devices can communicate via interface 806. In some implementations, the I/O interface can connect to interface devices including input devices (keyboard, gamepad or other game controller, pointing device, touchscreen, microphone, camera, scanner, etc.) and/or output devices (display device, speaker devices, printer, motor, etc.).

For ease of illustration, FIG. 8 shows one block for each of processor 802, memory 804, I/O interface 806, software blocks 808, 810, and 812, and database 814. These blocks may represent one or more processors or processing circuitries, operating systems, memories, I/O interfaces, applications, and/or software modules. In other implementations, device 800 may not have all of the components shown and/or may have other elements including other types of elements instead of, or in addition to, those shown herein. While the online gaming platform 102 is described as performing operations as described in some implementations herein, any suitable component or combination of components of online gaming platform 102 or similar system, or any suitable processor or processors associated with such a system, may perform the operations described.

A user device can also implement and/or be used with features described herein. Example user devices can be computer devices including some similar components as the device 800, e.g., processor(s) 802, memory 804, database 814, and I/O interface 806. An operating system, software and applications suitable for the client device can be provided in memory and used by the processor. The I/O interface for a client device can be connected to network communication devices, as well as to input and output devices, e.g., a microphone for capturing sound, a camera for capturing images or video, audio speaker devices for outputting sound, a display device for outputting images or video, or other output devices. A display device within the audio/video input/output devices 818, for example, can be connected to (or included in) the device 800 to display images pre- and post-processing as described herein, where such display device can include any suitable display device, e.g., an LCD, LED, or plasma display screen, CRT, television, monitor, touchscreen, 3-D display screen, headset, projector, or other visual display device. Some implementations can provide an audio output device, e.g., voice output or synthesis that speaks text.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various implementations. In some implementations, blocks and operations can be performed multiple times, in a different order, and/or at different times in the methods.

In some implementations, some or all of the methods can be implemented on a system such as one or more client devices. In some implementations, one or more methods described herein can be implemented, for example, on a server system, and/or on both a server system and a client system. In some implementations, different components of one or more servers and/or clients can perform different blocks, operations, or other parts of the methods.

One or more methods described herein (e.g., methods 400, 500, 600, and/or 700) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) executing on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method comprising:
receiving, by at least one processor, a request from a user device of a requesting user for one or more active game instances of a game platform that the user device is able to join, wherein the one or more active game instances are a subset of a plurality of active game instances currently executing on the game platform;
determining, by the at least one processor, one or more particular indexes in a data structure based on the request, wherein the one or more particular indexes are a subset of a plurality of indexes stored in the data structure, each of the plurality of indexes storing identifications of a respective subset of the plurality of active game instances;
obtaining, by the at least one processor, identifications of a set of candidate game instances from the one or more particular indexes of the data structure;
determining, by the at least one processor, a set of eligible game instances based on the identifications of the set of candidate game instances and based on eligibility criteria, wherein the set of eligible game instances are available for the user device to join; and
causing, by the at least one processor, the user device to connect to one of the set of eligible game instances.

2. The method of claim 1, wherein obtaining the identifications of the set of candidate game instances includes initially searching only the one or more particular indexes of the data structure prior to searching other indexes of the plurality of indexes.

3. The method of claim 1, wherein determining the one or more particular indexes based on the request includes determining one or more user characteristics of the requesting user and matching the one or more user characteristics to one or more game instance characteristics associated with the one or more particular indexes.

4. The method of claim 3, wherein the one or more user characteristics include at least one of: a geographical region of the user device, a language used by the requesting user, an age of the requesting user, a social network of the requesting user, or game type preferences of the requesting user.

5. The method of claim 3, wherein the one or more game instance characteristics associated with a respective index of the plurality of indexes are characteristics of the respective subset of game instances identified by the respective index, wherein the one or more game instance characteristics include at least one of: a geographical region of one or more servers executing the respective subset of game instances, one or more languages used by at least one player connected to the respective subset of game instances, social networks of players connected to the respective subset of game instances, ages of the players connected to the respective subset of game instances, or game types of the respective subset of game instances.

6. The method of claim 3, wherein the plurality of indexes are arranged in groups, each group associated with a different game instance characteristic and each group assigned a different priority when being scanned based on a corresponding user characteristic of the requesting user.

7. The method of claim 1, wherein the eligibility criteria include criteria associated with the requesting user or the user device of the requesting user.

8. The method of claim 1, wherein determining the set of eligible game instances includes:
determining that none of the set of candidate game instances meets the eligibility criteria;
determining one or more additional particular indexes in the data structure based on the request, wherein the one or more additional particular indexes are a subset of the plurality of indexes stored in the data structure;
obtaining identifications of a second set of candidate game instances from the one or more additional particular indexes of the data structure; and
determining the set of eligible game instances based on the identifications of the second set of candidate game instances.

9. A system comprising:
at least one processor coupled to a nontransitory computer readable medium having stored thereon software instructions that, when executed by the at least one processor, cause the at least one processor to perform operations including:
receiving game data that includes game events that indicate game state changes in a plurality of active game instances currently executing on a game platform;
for each of the game events:
obtaining the game event from the game data and determining whether the game event is an indexing event including one or more of: creation of a new game instance, update of one of the plurality of active game instances, or closing of one of the plurality of active game instances;
in response to determining that the game event is an indexing event, determining whether a particular game instance associated with the game event is eligible to be joined by one or more players;
in response to determining that the particular game instance associated with the game event is eligible to be joined by the one or more players, determining one or more index assignments for the particular game instance that target one or more particular indexes associated with one or more game instance characteristics of the particular game instance, wherein the one or more particular indexes are a subset of a plurality of game instance indexes that store references to the active game instances; and
writing one or more game state updates to the one or more particular indexes in a data structure based on the one or more index assignments,
wherein the one or more particular indexes are scanned to find eligible game instances based on the one or more game instance characteristics associated with the one or more particular indexes matching one or more user characteristics of a requesting user of the game platform requesting to join a game instance.

10. The system of claim 9, wherein the operation of determining whether the particular game instance associated with the game event is eligible to be joined by one or more players is based on whether the particular game instance is at least one of: private to particular players, closed or pending for closure, full of players, or prohibited from general users.

11. The system of claim 9, wherein the one or more game instance characteristics of the game event include at least one of: a geographical region of a server executing the particular game instance, a language used by at least one player connected to the particular game instance, a social network of the at least one player, age of the at least one player, or game type of the particular game instance, and
wherein the one or more user characteristics of the requesting user include at least one of: a geographical region of a user device of the requesting user, a language used by the requesting user, an age of the requesting user, a social network of the requesting user, or one or more game type preferences of the requesting user.

12. The system of claim 9, wherein the operation of receiving the game data includes receiving a stream of serialized game data that includes the game events provided by all game instances running on the game platform, and deserializing the game event from the serialized game data, and
wherein the operations further comprise:
determining a respective set of index assignments associated with each of a plurality of game events received in the game data; and
writing a plurality of game state updates to indexes in the data structure based on the game events and the associated sets of index assignments.

13. The system of claim 9, wherein the operations further comprise:
in response to receiving a request from a requesting user device of the requesting user:
determining the one or more particular indexes that are associated with the one or more game instance characteristics that match one or more user characteristics of the requesting user; and
scanning the one or more particular indexes to obtain the eligible game instances to which the requesting user is able to join; and
in response to determining that the one or more particular indexes do not store references to active game instances to which the requesting user is able to join, scanning one or more other indexes of the plurality of indexes for the one or more active game instances to which the requesting user is able to join.

14. A computer-implemented method comprising:
receiving, by at least one processor, an indication that original game instances of a game executing on a game platform are closing to enable an update of the game, wherein player devices of one or more players connected to the original game instances are to be disconnected from the original game instances for the update of the game;
storing, by the at least one processor, one or more player reservations for the one or more players in a stored reservation map that maps the one or more player reservations to one or more player slots of the original game instances;
updating, by the at least one processor, the game with one or more code changes to the game and executing one or more updated game instances for the game;
after the update of the game and disconnection of the player devices from the original game instances, receiving, by the at least one processor, a request from a player device of a requesting player to connect to the game;
in response to receiving the request, searching, by the at least one processor, the reservation map for an associated player reservation corresponding to the requesting player for the game; and
in response to finding the associated player reservation in the reservation map, connecting, by the at least one processor, a player device of the requesting player to one of the one or more updated game instances that corresponds to the original game instance associated with the associated player reservation.

15. The method of claim 14, wherein, in response to not finding the associated player reservation in the reservation map, performing, by the at least one processor, a matchmaking process to determine an active game instance or create a new game instance of the game to which the player device of the requesting player is able to connect,
wherein the matchmaking process includes determining scores for active game instances executing on the game platform, the scores based on one or more characteristics of the active game instances and one or more corresponding characteristics of the requesting player, and selecting the active game instance that has the highest score to connect to the requesting player, and
wherein the matchmaking process is skipped in response to finding the associated player reservation in the reservation map.

16. The method of claim 14, wherein the reservation map is a reservation index, wherein storing player reservations for the one or more players includes storing the player reservations in index entries of the reservation index, wherein the index entries respectively store references to the original game instances.

17. The method of claim 14, further comprising:
allocating, by the at least one processor, prepared game instances for the game on one or more servers prior to completion of the update of the game, wherein the prepared game instances correspond to the original game instances of the game; and
creating, by the at least one processor, one or more player slots in each of the prepared game instances, wherein the one or more player slots correspond to the one or more players,
wherein the reservation map maps the one or more player reservations to the one or more player slots of the prepared game instances, and
wherein the one or more updated game instances correspond to the prepared game instances.

18. The method of claim 17, wherein the one or more player slots are created in the prepared game instances such that each of the prepared game instances is allocated the same players as the corresponding original game instance.

19. The method of claim 14, further comprising allocating, by the at least one processor, one or more extra prepared game instances for the game before or while the game is updating, wherein a total number of prepared game instances is allocated that is greater than the number of original game instances.

20. The method of claim 14, further comprising removing, by the at least one processor, at least one player reservation of the one or more player reservations from the reservation map if an expiration time has passed for the at least one player reservation before a request is received from a player associated with the at least one player reservation.
